(19) United States
(12) Patent Application Publication
(10) Pub. No.: US 2026/0307101 A1
(43) Pub. Date: Oct. 8, 2026

(54) ELECTRON SHOWER INDUCED DEPOSITION SYSTEMS, METHODS OF USE THEREOF, AND METHODS OF MAKING NANOSTRUCTURES

(71) Applicant: Georgia Tech Research Corporation, Atlanta, GA (US)

(72) Inventors: Andrei G. FEDOROV, Atlanta, GA (US); Auwais AHMED, Atlanta, GA (US); Erik C. BOYLE, Atlanta, GA (US); Peter Arthur KOTTKE, Atlanta, GA (US)

(21) Appl. No.: 19/484,570

(22) PCT Filed: May 20, 2024
(86) PCT No.: PCT/US2024/030174

§ 371 Date: Nov. 14, 2025

Related U.S. Application Data
(60) Provisional application No. 63/503,820, filed on May 23, 2023.
(60) Provisional application No. 63/518,119, filed on Aug. 8, 2023.

(51) Int. Cl. B05D 1/00; C23C 18/14

(52) U.S. Cl. CPC B05D 1/007; C23C 18/14

(57) ABSTRACT

The present disclosure provides for methods and systems for making structures using a broad electron shower that interacts with a liquid in a high or low vacuum environment. The present disclosure provides for methods and systems for growing of high aspect ratio structures with three-dimensional topological complexity quickly by directing a liquid into an electron shower.

### CROSS-REFERENCE TO RELATED APPLICATION

This application claims priority to U.S. provisional application entitled “ELECTRON BEAM INDUCED DEPOSITION OF NANOMATERIALS FROM DISPERSED LIQUID PHASE PRECURSORS” having Ser. No. 63/503,820 filed on May 23, 2023 and this application also claims priority to U.S. provisional application entitled “ELECTRON SHOWER INDUCED DEPOSITION SYSTEMS, METHODS OF USE THEREOF, AND METHODS OF MAKING NANOSTRUCTURES” having Ser. No. 63/518,119 filed on Aug. 8, 2023, each of which is entirely incorporated herein by reference.

### STATEMENT ON FUNDING PROVIDED BY THE U.S. GOVERNMENT

This invention was made with Government support under contract DE-SC0010729 awarded by the Department of Energy. The Government has certain rights in the invention.

### BACKGROUND

Techniques using focused electron beams generally have the potential to lead to the highest resolution nanostructure synthesis. Extensive research has been conducted on the application of the focused electron beam for the fabrication of nanostructures. However, some techniques suffer from low growth rate and impurities due to parasitic carbon entrapment, unwanted deposition that compromises resolution. Thus, there is a need for a technique that can address these problems.

### SUMMARY

The present disclosure provides for methods and systems for making structures using a broad electron shower that interacts with a liquid in a high or low vacuum environment. The present disclosure provides for methods and systems for growing of high aspect ratio structures with three-dimensional topological complexity quickly by directing a liquid into an electron shower.

In an aspect, the present disclosure provides for a system comprising: a broad electron beam system for generating a shower of electrons, wherein the shower of electrons has a width of about 1 mm to 1 cm and a length of about 1 mm to 1 cm, wherein the shower of electrons have an energy of about 10 eV to 10 keV with a current of about 1 pA to 1 mA; and a spray system for directing a stream of liquid or liquid jet or liquid droplets into the shower of electrons, wherein the shower of electrons and stream of liquid or liquid jet or liquid droplets are under a pressure of about 10⁻⁶ bar to 760 Torr, wherein a portion of the shower of electrons collide with the stream of liquid or liquid jet or liquid droplets, wherein a solid nano-matter is formed via the chemical reactions in the stream of liquid or liquid jet or liquid droplets during interactions with the electron shower and forming a solid structure on collision with a substrate.

In an aspect, the present disclosure provides for a method, comprising: directing a liquid stream or liquid jet or liquid droplets towards a shower of electrons, where a portion of the shower of electrons collide with the liquid stream or liquid jet or liquid droplets, and forming a nano-matter as a result of the shower of electrons interacting with the liquid stream or liquid jet or liquid droplets which collide with a substrate and forming a solid structure, wherein the shower of electrons, the liquid, and the structure are under a pressure of about 10-6 bar to 760 Torr, wherein the shower of electrons have an energy of about 10 eV to 10 keV with a current of about 1 pA to 10 μA.

### BRIEF DESCRIPTION OF DRAWINGS

Further aspects of the present disclosure will be more readily appreciated upon review of the detailed description of its various embodiments, described below, when taken in conjunction with the accompanying drawings.

FIG. 1 illustrates a block diagram schematic of an embodiment of the present disclosure.

FIG. 2 illustrates a schematic of an embodiment of a system.

FIGS. 3A-3C and 4A-4C illustrate the formation of a structure using a liquid stream and liquid droplets.

FIG. 5 is an overview of the Droplet-to-Deposit Electron Beam Induced Deposition (D2D-EBID) system.

FIG. 6 illustrates nano-matter formation kinetics that are accelerated at the nanodroplet free surface.

FIG. 7 illustrates possible regimes of nanostructure formation using D2D-EBID.

FIG. 8 illustrates cycles for oxidizing Ag in water and aqueous ammonia.

FIG. 9A illustrates an electrosprayed precursor “beam” in D2D-EBID produces a high-aspect ratio nanopillar growing in outward direction from the liquid “beam” impingement spot on the substrate toward the nanoelectrospray emitter. FIG. 9B illustrates D2D-EBID that is used to create a 3D bridged structure formed by direct write of the precursor beam.

FIG. 10 illustrates two different techniques (film-on-the-substrate and in-flight-droplet spray) for liquid-phase precursor delivery.

FIG. 11 illustrates a schematic showing the solution of water and ammonia as solvent containing Ag⁺ and Ag(NH₃)₂⁺ precursor is nanoelectrosprayed onto the substrate and forms a film. As the solution is supplied to the substrate, the film size increases. Water and ammonia evaporate from the film surface slowing the growth of the film. The film reaches a quasi-steady state size and ammonia concentration as the evaporation balances the addition of solution via nanoelectrospray. The concentrations of non-volatile Ag⁺ and Ag(NH₃)₂⁺ precursors increase continuously (i.e., do not achieve a steady state value). The presence of Ag(NH₃)₂⁺ provides an additional source of stored ammonia, as a single Ag(NH₃)₂⁺ ion-complex releases two ammonia molecules if reduced to Ag.

FIGS. 12A-C is a schematic that illustrates the important chemical pathways for silver production in Liquid Phase Focused Electron Beam Induced Deposition (LP-FEBID) with an ammonia-water solvent and metal salt precursors (shown in green). The reducing species are illustrated in red and oxidizing species in blue. In the absence of NH₃ (FIG. 12A), the precursor Ag⁺ is converted to Ag via reduction by solvated electrons. The Ag can then be reverted to Ag⁺ via oxidation. The addition of ammonia to the solution (FIG. 12B) leads to partial conversion of Ag⁺ to Ag(NH₃)₂⁺. This adds an additional silver formation pathway as Ag(NH₃)₂⁺ can be reduced to Ag by H₂O₂. The role of H₂O₂ is shifted from purely an oxidizer of Ag to both an oxidizer and reducer. Presence of NH₃ also depletes the concentrations of oxidizing species O₂ and OH^{·}, making the environment more reducing. Further addition of NH₃ (FIG. 12C) amplifies this effect, leading to the environment becoming even more reducing. The size of each species oval indicates their relative concentrations for different cases.

FIGS. 13A and 13B illustrate Monte-Carlo simulation is used to calculate the dose rate distribution due to a 30 kV, 3 nA electron beam irradiation. FIG. 13A illustrates the simulation domain—a 1 μm thick liquid film is overlayed on a 0.1 μm gold layer, which is placed on a thick (treated as semi-infinite) silicon substrate. FIG. 13B illustrates the axisymmetric dose rate distribution within the liquid film. The origin (0,0) is the point of electron beam irradiation, and the axis of symmetry is the vertical line passing through this point. Due to negligible axial variation in dose rate, the problem can be simplified to 1D axisymmetric.

FIGS. 14A-C illustrate nanostructure deposition in water-ammonia solvents. FIG. 14A illustrates that in pure water or low ammonia, minimal nanostructure formation occurs due to oxidizing conditions. FIG. 14B illustrates that optimal ammonia concentrations for electrochemical lensing result in focused and rapid nanostructure growth with high resolution, as reducing conditions prevail in the near-field and oxidizing conditions prevent nanostructure formation in the far-field. FIG. 14C illustrates high ammonia concentrations lead to rapid growth of solid phase throughout the domain with loss of resolution, due to a reducing environment in both near and far-field.

FIGS. 15A-B illustrate simulated axisymmetric (mirrored around y-axis) Ag concentration profiles, after 1 second electron beam irradiation across different NH₃-water solution concentrations, for two initial AgNO₃ concentrations. Panel (FIG. 15A) shows the Ag concentration profile in a 26.5 mM AgNO₃ film, highlighting optimal NH₃ concentration for electrochemical lensing at 0.25 M NH₃; Panel (FIG. 15B) illustrates the 265 mM AgNO₃ scenario, where increased precursor availability leads to substantial far-field deposition even at very small NH₃ concentrations in the film, resulting in broadening growth and diminished resolution.

FIGS. 16A-D illustrate key reaction rates and concentrations in the near-field (center) for a 26.5 mM AgNO₃ solution at NH₃ concentrations of 0.1, 0.25, 1, and 3 M post 1 sec electron beam irradiation. Panel (FIG. 16A) illustrates the net instantaneous rate of silver deposition showing peak Ag creation in the near-field at 0.25 M NH₃. The net Ag silver deposition is the sum of all the reduction and oxidation pathways for precursors and Ag, respectively (FIG. 16B). Concentrations of key oxidizing and reducing species are shown in (FIG. 16C). Concentrations of Ag and the precursor ions are shown in (FIG. 16D), which indicates a partial conversion of Ag⁺ to Ag(NH₃)₂⁺ contributing to a negligible Ag creation at 0.1 M NH₃ (FIG. 16A). Additionally, decreasing precursor concentrations from 0.25 M to 3 M NH₃ in (FIG. 16D) is responsible for the drop in Ag creation.

FIGS. 17A-D illustrate key reaction rates and concentrations for far-field (4.5 μm from the center) silver deposition dynamics under varying NH₃ concentrations in a 26.5 mM AgNO₃ solution following electron beam exposure of 1 sec are shown. The net rate of Ag deposition (FIG. 17A) shows the increase in the rate of Ag creation in the far-field with higher NH₃ concentrations-this rate is the sum of all the reduction and oxidation reaction rates shown in (FIG. 17B). Concentrations of reducing and oxidizing species participating in creation or consumption of Ag are shown in (FIG. 17C). The Ag and precursor ions concentrations (FIG. 17D) show an increase in far-field Ag creation with increased NH₃, as well as a corresponding drop in the precursor ion concentrations.

FIGS. 18A-F illustrate the impact of NH₃ concentration on Ag⁺ and Ag(NH₃)₂⁺ diffusion and Ag creation under a 30 kV electron beam for 1 second. In low NH₃ or pure aqueous conditions (FIG. 18A), oxidizing conditions inhibit Ag formation, with minimal ion diffusion. At optimal NH₃ concentration (FIG. 18B), a reducing environment in the near-field promotes precursor cations Ag⁺ and Ag(NH₃)₂⁺ conversion to Ag, while maintaining oxidizing conditions in the far-field, promoting precursor cation diffusion towards the near-field. Higher NH₃ concentrations (FIG. 18C-D) lead to Ag⁺ and Ag(NH₃)₂⁺ conversion in both the near-field and far-field, decreasing precursor cations available for diffusion towards near-field and slowing Ag growth. Panel (FIG. 18E) highlights the maximum diffusion of Ag⁺ and Ag(NH₃)2+towards the near-field at 0.25M NH₃, marking it as the optimum concentration for electrochemical lensing. Increasing NH₃ to 1M and 3M reduces the rates of diffusion, slowing the near-field Ag growth. Panel (FIG. 18F) shows the diffusive flux profiles, indicating a reversal in diffusion direction at 1 M and 3 M NH₃ concentrations due to the local precursor cation concentration minima.

FIGS. 19A-J illustrate AFM images of nanostructures from NanElectroSpray-Assisted Focused Electron Beam Induced Deposition (NESA-FEBID) using water-ammonia solutions with 250 μM AgNO₃ at 30%, 25%, and 15% NH₃ concentrations in top-view 2D (FIG. 19A-C) and 3D (FIG. 19D-F) radial profiles. Nanostructures are created with 1 s 30 kV electron beam in ‘spot’ mode. Ag growth varies with NH₃ concentration, showing focused near-field growth at 15% NH₃ and increased far-field growth at 25% and 30% NH₃. Normalized experimentally determined pillar profiles (FIG. 19J) are compared to simulated Ag concentration profiles at varying NH₃ levels, showing qualitative agreement and presence of an optimal NH₃ concentrations for focused near-field Ag growth, the signature of the electrochemical lensing.

FIG. 20 illustrates various chemical equations in the Examples.

### DETAILED DESCRIPTION

The present provides for methods and systems for making structures (e.g., nanostructures) using a broad electron shower that interacts with a liquid in a high or low vacuum environment.

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of analytical chemistry, microscopy, imaging, biotechnology, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in °C, and pressure is in bar. Standard temperature and pressure are defined as 0 °C and 1 bar.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Discussion:

Embodiments of the present disclosure provide for methods and systems for making structures (e.g., nanostructures) using a broad electron shower that interacts with a liquid (e.g., a stream of liquid or jet of liquid or droplets of liquid) in a high or low vacuum environment (e.g., 10⁻⁶ to 760 Torr). The present disclosure provides for methods and systems for growing of high aspect ratio structures with three-dimensional topological complexity quickly by directing a liquid into an electron shower. In particular, an embodiment of the present disclosure provides for methods and systems for ultra-fast growth of high aspect ratio nano/meso/micro-structures with three-dimensional topological complexity and control of phase and composition of the structure formed. The structure can be formed using a liquid stream/jet/droplets that are directed into an electron shower, where the compounds of the liquid interact with the electron shower and form the structure (e.g., deposition). The present disclosure is advantageous in that precise and discrete structures can be formed with a substantial reduction or elimination of parasitic deposition.

The present disclosure provides for the fabrication of multiscale hierarchical materials with control of structure (phase and chemical composition) down to the atomic scale in a physical environment and at thermodynamic conditions that are of practical relevance to nanoscience and nanoengineering applications. The present disclosure provides embodiments that can overcome previous limitations such as poor topology control and resolution due to e-beam out-scattering in solution, floating deposits that cannot attach to the substrate, resulting in little to no formation of stable structures, deposited structure height and width (e.g., aspect ratio) constraints, and/or parasitic (off-target) depositing due to significant liquid layer motion.

In a particular aspect, the present disclosure can cause deposition to occur within the confines of a stream of liquid (e.g., an attoliter (~10-18 L) nanodroplets or narrow (e.g., about 100 nm to 100 μm) stream of liquid), which can act as dynamic electrochemically active “liquid nanoreactors” with electron shower induced solid nano-matter formation, where the electrons are from the broad electron shower. Nanostructure growth occurs through liquid-nucleated (e.g., droplet-nucleated) nano-matter aggregation and fusion with the assistance of a scanning electron shower. The extreme surface area of ultra-small and highly charged nanoelectrospray (e.g., droplets), in which the radiolysis-induced reactions occur places emphasis on highly non-equilibrium transport-reaction interactions at the solution-vacuum interface. Embodiments of the present disclosure can provide a way of forming very tall (10 s of μm) and high aspect ratio (e.g., about 100:1) structures with unprecedented control of three-dimensional shapes along with substantial reduction (e.g., about 90% or more or about 95% or more reduced parasitic deposition) or the complete absence of parasitic (off-target) deposition.

Use of the liquid stream or liquid droplets of the present disclosure allows for far-from-equilibrium environments within a high or low vacuum deposition system to take advantage of variables such as control the transport (currents) of all charged species (e.g., precursor ions, solvent ions, incoming beam electrons and outgoing reduction reaction electrons) during deposition with sub-millisecond time resolution. Unique thermodynamic state variables and charge conversion processes allow for new kinetic deposition pathways, which can be combined with in-situ visualization of the evolving liquid-solid interfaces and deposit nucleation, aggregation, attachment, and densification. As a result, the present disclosure allows for production of nanoparticles that would be difficult or impossible to form in other systems, specifically where the present system and method can use electron showers and wide range of pressures and not limited to high vacuum systems to form having much higher aspect ratios.

The present disclosure provides the devices and systems that can make structures ranging from nano to microscale that are of great practical importance in the field of nano-sciences and engineering. In particular, the present disclosure provides for devices, systems, and methods for direct write nanofabrication and patterning of functional micro/nano materials and devices, including those used in microelectronics, photonics, quantum communications, and sensing. The present disclosure is advantageous in that it enables ultra-high resolution, high growth rate, and/or high purity and crystallinity of the material production of high aspect ratio nanostructures. The present disclosure provides for devices, systems, and methods for producing nanostructure that can be used in solar photovoltaics devices, batteries, biomachinery, and integrated circuits.

Embodiments of the present disclosure are advantageous for at least the reason that: (1) increasing the growth rate of deposition/etching of the structures, (2) enabling deposition of composite materials and alloys with tailored electromechanical properties, and (3) fabrication of new, truly three-dimensional topologies of structures that cannot be fabricated using similar techniques. In addition, the advantages are realized using a broad electron shower that can operate a low pressure or near atmospheric pressure to produce structures that can have high aspect ratios giving aspects of the present disclosure significant advantages over other techniques.

Embodiments of the present disclosure provide for growth rates of structures that can be 3-5 orders of magnitude faster than rates reported from other similar techniques and formation of unique three dimensional topologies, such as rods, particles, nanoscale bridges, bridge-like “arch” structures, fusing two or more deposits, scaffolds, and simultaneously vertical and side-growing/merging structures (e.g., nanostructures), using a liquid stream or jet or droplets that are directed into a shower of electrons in a high or low vacuum environment.

An embodiment of the present disclosure provides for a system of forming (e.g., deposition and/or etching) structures. An embodiment of the system includes a broad electron beam system and spray system. A substrate can be included where the particles are formed and/or deposited, where forming the structure is performed under pressures of high vacuum up to atmospheric pressure. In addition, the system can include a computer(s) system that can be in communication with one or more components of the system and/or in communication with computers that operate one or more of the components of the system. In an embodiment, the computer system can be used to acquire and/or manage various data such formation of the liquid stream or droplets, formation of the particle on the substrate, temperature of the substrate and/or system, pressure in the deposition chamber, electron beam current, and the like.

In an aspect, the system includes a broad electron beam system that can generate a broad shower of electrons. In one embodiment the broad electron shower is in a vacuum, so that the electrons in the electron shower are not attenuated or scattered and can be more precisely controlled, but this is not necessary as the pressure can be up to about atmospheric pressure (with the electron shower, in some cases being of low energy, and can be focused or unfocused), and the process for forming the particles do not require unattenuated electrons and with the electrons being a shower of electrons, scattering is of little importance. The broad electron beam system includes a source of electrons and electron focusing optics for controlling the flux and direction of electrons. The broad electron beam system can be a thermal emission electron source, field emission electron source, spark plasma source or another plasma generation device having electron focusing optics can generate and direct the shower of electrons towards the substrate. The electron focusing options can be an arrangement of electrodes that are connected to the power supplies that can apply the voltage configuration such that an appropriate electric field is established allowing control of electron flow, energy, and spatial confinement to produce the shower of electrons. The shower of electrons can have a width of about 1 mm to 10 cm and a length of about 1 mm to 10 cm, about 10 mm to 10 cm and a length of about 10 mm to 10 cm, or about 1 mm to 1 cm and a length of about 1 mm to 1 cm. The shower of electrons is not a focused electron beam, which is much narrower. A shower of electrons is different than a focused electron beam. The shower of electrons can have an energy of about 10 eV to 30 keV with a current of about 1 pA to 1 mA or about 100 eV to 250 eV with a current of about 10 pA to 10,000 μA. In an aspect the broad shower of electrons can be unfocused or focused. For example, the shower of electrons could be produced by raster scanning of the focused beam of electrons such as, for example, used in the scanning electron microscope.

The system can also include a spray system for directing a stream of liquid or liquid jet or liquid droplets into the shower of electrons. The shower of electrons and stream of liquid or liquid droplets can be under a pressure of about 10⁻⁶ bar to 760 Torr, about 5 Torr to 760 Torr, about 10⁻⁶ to 5 Torr, about 5 Torr to 760 Torr, about 30 Torr to 760 Torr, about 10-6 bar to 30 Torr, or about 760 Torr. A portion of the shower of electrons collide with the stream of liquid or liquid droplets to form nano-matter. As the stream of liquid or liquid droplets move through the shower of electrons, the chemical compounds in the stream of liquid or liquid jet or liquid droplets react to form the solid structure(s) as described above and herein. A solid structure can be formed from the stream of liquid or liquid jet or liquid droplets after a sufficient number of collisions with the electron shower. The liquid from the spray system does not form a liquid film on the substrate like other systems.

In an aspect, the system can include a temperature sensing and control element to control temperature of the substrate. For example, a resistive heating and electrical resistance thermometry can be used as the temperature control and sensing elements or it could be a thermoelectric element, which could be both a temperature sensor and thermal control element for heating or cooling. In another aspect, the spray system includes the temperature sensing and control element to control the temperature of the substrate.

In an embodiment, a substrate can be positioned relative to the electron shower and the liquid system so as to deposit and/or form particles on the substrate. In an embodiment, the substrate can be positioned on a stage position and control system that can include a stage that can be used to move the substrate relative to the electron shower and/or the spray system so that the position at which the structure is formed is known and the position can be adjusted to form structures at various locations on the substrate. The stage can be used to move a substrate in the x-, y-, and/or z-directions relative to the electron shower and/or the spray system. In an embodiment, the stage and the electron shower and/or the spray system can be moved in the x-, y-, and/or z-directions relative to one another. In an embodiment, the stage can include a cooling/heating system to control the temperature of the substrate, which can be used to control the rate of different reactions promoted by the electron shower thus achieving selectivity towards desired deposition/etching chemistry pathway as well as the adherence of the deposited material to the substrate surface. In an embodiment, cooling/heating system can include a thermoelectric device independently or integrated into a stage, Peltier cooler/heater, a liquid cooled/heated stage, a phase-change thermal energy storage material (PCM), resistance heaters, and the like. In an embodiment, the substrate can include gold, palladium, gold-palladium, silver, aluminum, graphene, or ITO (Indium Tin Oxide), polymers, Si/SiO₂, combinations thereof, and the like.

In an aspect, the liquid can be delivered using an electrospray (e.g., nanoelectrospray) jetting process into the vacuum environment of a deposition chamber. In this regard, an “energetic jet” is used to control delivery of energized/activated precursors into the shower of electrons. Use of the electrospray system enables the formation of high-resolution, topologically-complex three dimensional structures from a liquid-phase precursor. In general, the liquid precursor is directly delivered from the electrospray tip into the shower of electrons. The electrospray can serve the purpose of controllable liquid injection and variations in applied potential near the spray onset and adjustments in spray tip positioning can be used to make small adjustments in the flow rate. Embodiments of the present disclosure allow purely aqueous and organic solvents as well as mixtures to be delivered by electrospray jets. This approach demonstrates the capabilities for electron-beam deposition of different materials, ranging from pure metals to carbon based on the type of liquid precursor.

In an embodiment, the electrospray system can include one or more electrospray capillary tips. In an embodiment, the electrospray capillary tip can have an orifice diameter of about 1 μm to 5 μm or 10 μm to 100 μm and capillary length can be about 1 mm to 10 mm or about 1 cm to 10 cm. The capillary tip can be positioned (e.g., about 10 μm to 1 mm or 1 mm to 10 mm away from the substrate) relative to the electron shower to deposit and/or form the particles on the substrate. In an embodiment, the capillary can be prefilled with a liquid or the capillary can include a system to flow liquid to the capillary to be ejected. The electric field of the electrospray system can be selected so that no liquid film forms on the substrate. The electric field can be generated by applying a bias potential (e.g., a positive or negative bias potential) to the capillary, and the substrate is held at or near ground. Alternatively, the electric field could be created by holding the capillary at or near ground, and applying a bias potential (e.g., a positive or negative bias potential) to the substrate.

As mentioned above, the electrospray system can include two or more electrospray capillary tips, where each electrospray capillary tip can independently direct a liquid into the electron shower. The liquid emitted from each electrospray capillary tip can be the same or different.

In an embodiment, the electric field to induce electrospray applied relative to the ground electrode of the electrospray system can be about 500 V/mm to 1500 V/mm. In an embodiment, the electric field of the electrospray system can be adjusted using one or more of the following: the properties of the sprayed liquid, tip geometry, orientation relative to the substrate, combinations thereof and the like. In an embodiment, a bias between the electrospray capillary tip and the substrate is about 200 to 600 V and a spray current of about 10 pA to 100 nA. In an embodiment, the electrospray system has a liquid delivery rate of about 0.01 nL/s to 100 μL/s or about 1 nL/s to 100 nL/s.

In an embodiment, the capillary tips can be pulled glass capillaries (sampling orifice dimensions from 200 nm to 2 μm) and the external surface can be made non-wetting via silanization to prevent flooding, and electrospray voltage applied to the liquid/vapor interface via an internal wire counter-electrode.

One embodiment of the electrospray system includes a capillary with an integrated counter electrode to generate electrospray. Fused silica sampling capillaries have been used and can have about a 1 μm inner diameter to 50 μm inner diameter and can be about 8 mm to 3 cm in length. All of the capillaries have a tapered outer diameter at the spray end. Capillaries can be purchased (New Objective Silica Tips), while others are originally fabricated in-house using meniscus etching. Further details are available in reference (Kottke, P. A., Degertekin, F. L., and Fedorov, A., The Scanning Mass Spectrometry Probe: a scanning probe electrospray ion source for imaging mass spectrometry of submerged interfaces and transient events in solution, Anal. Chem., 82 (1), 19-22 (2010), which is included herein by reference) In an embodiment, the electrospray system includes appropriately interfaced (e.g., electrically isolated) components so that different electric potentials can be applied to produce an appropriate electric field for driving the liquid via electromotive force. Upon application of an appropriate electric potential (voltage) to the capillary tip, a Taylor cone of the liquid is electrohydrodynamically-induced and extends out through the orifice of the tip. The Taylor cone of the solution is sprayed out of a capillary tube filled with the liquid to form a cone and disperse liquid into droplets that are directed to the substrate, where a droplet of liquid is formed. The formation of the Taylor cone is dependent, at least, upon the liquid, the diameters of the orifice, one or more of the applied electric potentials (electrode voltages), the electrode locations, the strength and orientation of the electric field, and the like.

In a particular embodiment a prefilled pulled glass capillary can be mounted in the vacuum chamber (e.g., SEM chamber) and the capillary tip is brought near (e.g., about 100 μm to 5 mm) to the substrate. A high-voltage power supply can be used to apply a positive bias (e.g., about 500 V to 2500 V) to the capillary, and the substrate is held at or near ground, depending on whether or not current is being measured using a picoammeter to allow for high-precision nanoelectrospray current measurement. The onset of electrospray can be determined by observing through the SEM detector the formation of the electrohydrodynamic Taylor cone and the accumulation of liquid on the substrate, and changes in the measured current by picoammeter. In an embodiment, the electron beam can be blanked during electrospray to allow for only the contribution of current due to spray to be measured. Liquid accumulation on the substrate can be controlled by initiating spray and adjusting the potential and the tip/substrate gap until a droplet of desired width is observed. Then, the potential can be slowly reduced (e.g., the rate of reduction depends, at least upon the application, liquid, pressure, temperature and the like) until the pool is reduced to a liquid film or completely eliminated from the substrate.

In other aspects, liquid can be delivered using a non-electrospray system. The non-electrospray system is an inkjet printhead, an acoustic droplet generator, or a pressure-driven liquid atomizer. The droplets can have a diameter of about 10 nm to 100 μm as they exit the non-electrospray system. The liquid stream can have a diameter of about 10 nm to 100 μm as they exit the non-electrospray system. The liquid delivery rate can be about 0.01 nL/s to 100 μL/s or about 1-100 nL/s.

In other aspects, the liquid stream or liquid jet or liquid droplets could be co-flowing with a gas or gas jet to be able to control the direction (velocity vector) and kinetic energy of the liquid stream or liquid jet or liquid droplets using a drag force, such that it can control the time of interactions between the liquid stream or liquid jet or liquid droplets and the electron shower as well as direct the liquid onto a specific location on the deposition substrate. The gas jet could move sub-sonic, trans-sonic, or supersonic speed and its temperature could be changed to control the interactions with and temperature of the liquid stream or liquid jet or liquid droplets. These interactions include the rate of the liquid evaporation, kinetics of the chemical reactions, magnitude of the drag force, etc.

As mentioned above, the system can be operated in a high vacuum or at atmospheric pressure and any pressure in between. In an aspect, a compartment (e.g., SEM system) housing the substrate can be held at vacuum (e.g., a pressure of 10⁻⁶ bar to 760 Torr and various therein), where the spray system is configured to deliver the liquid in the compartment house under vacuum, where the electron shower is transmitted in the compartment under vacuum. In addition, the tip of the spray system (e.g., a capillary tip) can be disposed within the vacuum. The vacuum in the compartment can be maintained using one or more vacuum pumps as are known in the art to achieve the desired pressure.

As previously described, the system can be at a pressure of about 10-6 bar to 760 Torr, about 5 Torr to 760 Torr, about 10⁻⁶ bar to 5 Torr, about 5 Torr to 760 Torr, about 30 Torr to 760 Torr, about 10⁻⁶ bar to 30 Torr, or about 760 Torr. The pressure can be controlled using vacuum pumps and monitored using various pressure gauges depending upon the pressure. As described herein, some components are under a vacuum while others can be positioned outside of the compartment with the controlled pressure.

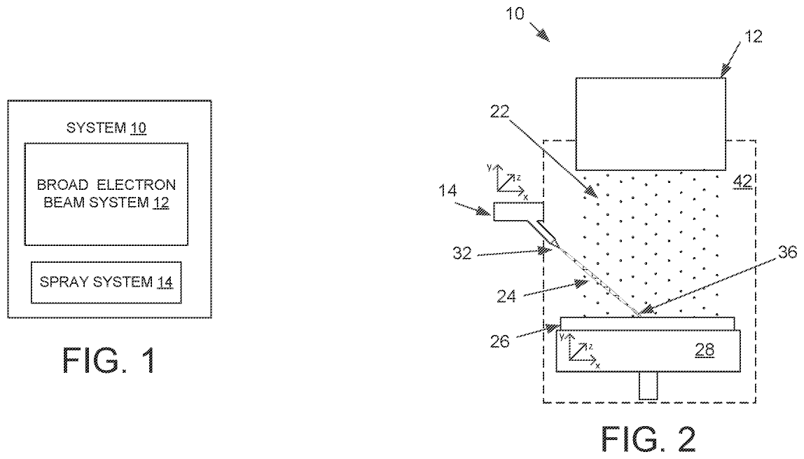

Now having described the system in general, the following provides additional details regarding the system and components of the system. FIGS. 1 and 2 are schematics of an embodiment of a system 10. In an embodiment, the system 10 includes a broad electron beam system 12 that emits a shower of electrons 22 towards a substrate 26. The system 10 also includes a spray system 14 that directs a liquid 24 (e.g., a stream or jet or droplets) into the shower of electrons 22. The liquid 24 (shown as a liquid stream) interacts with the shower of electrons 22 to produce nano-matter and then (e.g., form or deposit) a structure 36 on the substrate 26. The substrate 26 can be positioned on a stage 28 that can be adjusted to form a structure 36 at different locations on the substrate 26 or to form the structure 36 with different shapes. The shower of electrons 22, the liquid 24, the substrate 26, the substrate 26, the stage 28, and optionally the spray tip 32 can within a compartment 42 that is under a vacuum or at atmospheric pressure.

In an embodiment, the method of forming a structure include forming a structure by directing a liquid into the shower of electrons. The liquid can be directed using a spray system such as an electrospray system. While other types of spray systems can be used, the following discussion describes the use of an electrospray system. The compartment housing the shower of electrons (e.g., an energy of about 0.3 to 30 keV with a current of about 1 pA to 1 μA), the electrospray system (or at least the tip of the electrospray system), and the substrate are in a vacuum (e.g., a pressure of 10⁻⁶ bar to 30 Torr). The liquid can be directed into the shower of electrons for a variable amount of time (e.g., about 1 microsecond to 1 second) depending upon the deposition to be performed, the size of the structure to form, properties of the liquid, electrospray flow rate, pressure and temperature in the chamber, and the like. In an embodiment, the deposition can be about 0.1 μm³/s to about 10 μm³/s. The liquid does not form a pool of liquid on the surface of the substrate since the structure is formed as the liquid contacts the substrate or the structure (in the process of being built) as described above and herein.

In a particular aspect, the method can include directing a liquid stream or liquid droplets towards a shower of electrons. A portion of the shower of electrons collide with the liquid stream or liquid droplets to form nano-matter. A structure can ultimately be formed as a result of the shower of electrons colliding with the liquid stream or liquid jet or liquid droplets. The shower of electrons, the liquid, and the structure are under a pressure of about 10⁻⁶ bar to 760 Torr. The shower of electrons can have an energy of about 10 eV to 10 keV with a current of about 1 pA to 10 μA.

In an embodiment, the liquid and the shower of electrons can be used to form a first structure. The first structure is formed in the first area of the substrate as the liquid (after interaction with the electron shower) lands on the structure. The interaction of the liquid and the shower of electrons prior to contact with the structure initiates the formation of the nano-matter that can ultimately form the structure. In other words, as the liquid moves through the shower of electrons the liquid is progressing toward formation of the structure as described above and herein. In an embodiment, the formation of the first structure can include keeping the spray system stationary for a period of time to form the desired first structure (e.g., a pillar) or the spray system and/or stage can be moved in a manner to form a first structure having a more complex shape such as a bridge structure, an overhang structure, a suspended cantilever, a hollow volcano-like fiber, wall-like structures, scaffold structure, and suspended grid array of interconnected lines. In addition, multiple structures can be made using one or more spray system and two or more of these structures can be interconnected by movement of the sprays system and/or stage. In this regard, many different types of structures can be formed in a sequential or simultaneous manner.

In an embodiment, the deposition can be used to form a structure or structures (e.g., scaffold) adjacent or around a material (e.g., a biological material such as a cell or tissue). In this way the structure(s) can be formed on, and/or within the biological material. Selection of the liquid(s) can be based on favorable interaction with the biological material and having a precursor that results in deposition of material compatible with the biological material with favorable interactions (e.g., promoting cell growth or biological material incorporation into a deposited matrix). In an embodiment, the structure(s) (e.g., the first structure, forming the second structure, or a combination of thereof) form a scaffold, where the biological material and the scaffold are integral to one another. As used herein, the term “integral” refers to the biological material and the scaffold intermingled, for examples, cells can be positioned within the interior and/or exterior of the scaffold or the scaffold can from a superstructure to support a tissue. As a result, the use of multiple processing steps of deposition can be used to achieve “net shape control” of the structures.

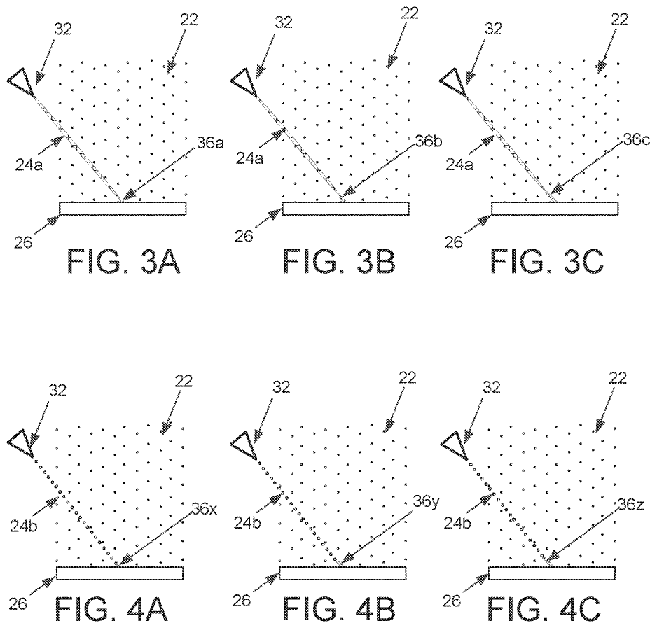

FIGS. 3A-3C and 4A-4C illustrate the formation of a structure using a liquid stream and liquid droplets. FIG. 3A illustrates the initial formation of the structure 36a. The liquid stream 24a is directed into the shower of electrons 22 using the tip 32 of the spray system. The structure 36a is illustrated on the surface of the substrate 26. FIG. 3B illustrates the structure 36b as it grows larger. FIG. 3B shows that the structure 36b is the result of the liquid 24a continually interacting with the shower of electrons 22 to build the structure. FIG. 3C illustrates the structure 36c as it continues to grow as the liquid 24a continues to interact with the shower of electrons 22. This can continue for a time frame sufficient to form the desired structure. As can be seen, a liquid pool is not formed on the substrate 26, which is due to the process of formation of the structure as the liquid stream 24a interacts with the shower of electrons 22. One advantage of this process is that parasitic material is not formed around the structure, which is unlike some other systems.

FIGS. 4A-4C are similar to FIGS. 3A-3C with the difference being that FIGS. 4A-4C illustrate the use of liquid droplets 24b to form structure 36x, 36y, and 36z, respectively in FIGS. 4A-4C.

In an embodiment, the liquid can be an aqueous solvent, an organic solvent, an electrochemically active compound, and a combination thereof. In an embodiment, the liquid can include dissolved salts, bases, acids, particles (e.g., nanoparticles such as magnetic materials (e.g., iron, cobalt), plasmonic structures (e.g., silver, gold), or silica, alumina, titania nanoparticles, or biological materials and biopolymers (e.g., cells, proteins, DNA, hydrogel capsules) and the like. In an embodiment, the liquid includes a carbon structure precursor material such as glycol (e.g., ethylene glycol), alcohol (e.g., C1 to C6 alkyl alcohols such as methanol), and the like. In an embodiment, the liquid can include a metal structure (or metal alloy structure) precursor such as a metal salt (e.g., silver nitrate or copper nitrate) or copper sulfate or chloroplatinic acid or ionic liquids. In an embodiment, the solvent can include water, ammonia, methanol, ethanol, chloroform, acetonitrile, ionic liquids, ethylene glycol, an acid (e.g., chloroplatinic acid, sulfuric acid), or a combination thereof. In an embodiment, the composition of the precursor material in the liquid can be adjusted as needed to achieve the desired growth (deposition) or material removal (etch) rate. In an embodiment, the solvent includes water and ammonia, where the ratio between the ammonia and water by volume percent is about 0.1 (ammonia): 99.9 (water) to 30 (ammonia): 70 (water). Additional details regarding the NH₃ chemistry can be found in Science Advances, 17 Dec. 2021, Vol 7, Issue 51, which is incorporated herein by reference,

The selection of the liquid can be used to determine the material content of the structure to be formed. For example, a precursor having an appropriate carbon content can be used to form a carbon structure. In an embodiment, a metal salt can be used as a precursor to form a metal or metal alloy structure. To form a composite material, different precursors (one precursor can be a silver metal salt and a second precursor can be a carbon precursor material) can be used in the same step (when liquid contains both precursors) or different steps (when liquid contains one precursor at the time) to form the composite structure of various composition and morphological structure. In one aspect, the liquid is ethylene glycol. In another aspect, the liquid includes water, ammonia, and a metal salt (e.g., AgNO₃)

The dimensions of the structure can depend upon the characteristics of electron shower, the size of the liquid stream or liquid jet or liquid droplets, flow rate of the liquid and the components in the liquid, as well as the time frame of the interaction with the electron shower. In general, the structure can have a diameter of about 1 nm to 5 μm and a height of about 1 nm to 50 μm. In an aspect, the structure has a width of about 5 nm to 750 μm and a height of about 1 nm to 750 μm or about a width of about 50 nm to 500 μm and a height of about 50 nm to 500 μm or about 60 to 500 μm and a height of about 60 nm to 500 μm. In an aspect, the structure can have an aspect ratio (height to width) of 1:1 to 100:1. In another aspect, the structure can have an aspect ratio (height to width) of 0.1:1 to 500:1. However, the process can be designed to form a structure that has larger or smaller dimensions as well as very complex structure with variable dimensions so that a multitude of shapes or designs can be envisioned. For example, the structure can have one of the following shapes: a pillar, a bridge structure, an overhang structure, a suspended cantilever, a hollow volcano-like fiber, wall-like structures, suspended grid array of interconnected lines, a scaffold, and combinations of these.

Various combination of features of the present disclosure are described below that are in addition to those described above, in the claims, and herein. Each of these combinations are intended to be described and can be claimed.

Aspect 1. A system comprising: a broad electron beam system for generating a shower of electrons, wherein the shower of electrons has a width of about 1 mm to 1 cm and a length of about 1 mm to 1 cm, wherein the shower of electrons have an energy of about 10 eV to 10 keV with a current of about 1 pA to 1 mA (or optionally about 100 eV to 250 eV with a current of about 10 pA to 10,000 μA); and a spray system for directing a stream of liquid or liquid jet or liquid droplets into the shower of electrons, wherein the shower of electrons and stream of liquid or liquid jet or liquid droplets are under a pressure of about 10−6 bar to 760 Torr, wherein a portion of the shower of electrons collide with the stream of liquid or liquid jet or liquid droplets, wherein a solid nano-matter is formed via the chemical reactions in the stream of liquid or liquid jet or liquid droplets during interactions with the electron shower and forming a solid structure on collision with a substrate.

Aspect 2. The system as described above, below and herein, wherein the pressure is about 5 Torr to 760 Torr (or optionally about 10-6 to 5 Torr or about 5 Torr to 760 Torr or about 760 Torr).

Aspect, 3. The system as described above, below, and herein, wherein the liquid from the spray system does not form a liquid film on the substrate.

Aspect 4. The system as described above, below, and herein, wherein the broad electron beam system includes a source of electrons and electron focusing optics for controlling the flux and direction of shower of electrons.

Aspect 5. The system as described above, below, and herein, wherein the spray system is a non-electrospray system.

Aspect 6. The system as described above, below, and herein, wherein the non-electrospray system is an inkjet printhead, an acoustic droplet generator, or a pressure-driven liquid atomizer.

Aspect 7. The system as described above, below, and herein, wherein the droplets have a diameter of about 10 nm to 100 μm as they exit the non-electrospray system.

Aspect 8. The system as described above, below, and herein, wherein the liquid stream or jet has a diameter of about 10 nm to 100 μm as they exit the non-electrospray system.

Aspect 9. The system as described above, below, and herein, wherein the spray system has a liquid delivery rate of about 0.01 nL/s to 100 μL/s (or optionally about 1-100 nL/s).

Aspect 10. The system as described above, below, and herein, wherein the spray system is an electrospray system that includes an electrospray capillary tip (optionally wherein the electrospray capillary tip has an orifice diameter of about 100 nm to 100 μm or about 1 μm to 10 μm).

Aspect 11. The system as described above, below, and herein, wherein the electrospray system has a liquid delivery rate of about 1 nL/s to 100 nL/s.

Aspect 12. The system as described above, below, and herein, further comprising a temperature sensing and control element to control temperature of the substrate or wherein the spray system includes the temperature sensing and control element to control the temperature of the substrate.

Aspect 13. The system as described above, below, and herein, wherein the substrate is configured to move along or rotate about the x-axis, y-axis, and/or z-axis.

Aspect 14. The system as described above, below, and herein, wherein the spray system is configured to move along or rotate about the x-axis, y-axis, and/or z-axis.

Aspect 15. A method, comprising: directing a stream of liquid or liquid jet or liquid droplets towards a shower of electrons, where a portion of the shower of electrons collide with the liquid stream or liquid jet or liquid droplets, and forming a nano-matter as a result of the shower of electrons interacting with the liquid stream or liquid jet or liquid droplets which collide with a substrate and forming a solid structure, wherein the shower of electrons, the liquid, and the structure are under a pressure of about 10⁻⁶ bar to 760 Torr, wherein the shower of electrons have an energy of about 10 eV to 10 keV with a current of about 1 pA to 10 μA.

Aspect 16. The method as described above, below, and herein, wherein the structure has a width of about 5 nm to 750 μm and a height of about 1 nm to 750 μm (or optionally about a width of about 50 nm to 500 μm and a height of about 50 nm to 500 μm or about 60 to 500 μm and a height of about 60 nm to 500 μm).

Aspect 17. The method as described above, below, and herein, wherein the structure has an aspect ratio (height to width) of 1:1 to 100:1.

Aspect 18. The method as described above, below, and herein, wherein the structure has about 0.1:1 to 500:1.

Aspect 19. The method as described above, below, and herein, wherein the structure is a carbon structure, a metal structure, a metal alloy structure, a metal-carbon composite structure, a metal-polymer structure, and a carbon-biological material structure.

Aspect 20. The method as described above, below, and herein, wherein the structure is selected from the group consisting of: a pillar, a bridge structure, an overhang structure, a suspended cantilever, a hollow volcano-like fiber, a wall-like structure, a porous 3D scaffold, a scaffold, and suspended grid array of interconnected lines.

Aspect 21. The method as described above, below, and herein, wherein the liquid is selected from the group consisting of: an aqueous solvent, an organic solvent, an electrochemically active compound, and a combination thereof.

Aspect 22. The method as described above, below, and herein, wherein the liquid comprises ethylene glycol.

Aspect 23. The method as described above, below, and herein, wherein the liquid is a metal salt, ammonia, and water.

Aspect 24. The method as described above, below, and herein, wherein the ratio between the ammonia and water by volume percent is about 0.1:99.9 to 30:70.

Aspect 25. The method as described above, below, and herein, wherein the pressure is about 5 Torr to 760 Torr (or optionally about 10-6 to 5 Torr or about 5 Torr to 760 Torr or about 760 Torr).

Aspect 26. The method as described above, below, and herein, wherein the liquid does not form a liquid film on the substrate.

Aspect 27. The method as described above, below, and herein, wherein the droplets have a diameter of about 10 nm to 100 μm as they exit the non-electrospray system.

Aspect 28. The method as described above, below, and herein, wherein the liquid stream has a diameter of about 10 nm to 100 μm as they exit the non-electrospray system.

Aspect 29. The method as described above, below, and herein, wherein the spray system has a liquid delivery rate of about 0.01 nL/s to 100 μL/s (or optionally about 1-100 nL/s).

Aspect 30. The method as described above, below, and herein, wherein forming the structure includes a growth rate of about 0.1 μm³/s to about 10 μm³/s.

Aspect 31. The method as described above, below, and herein, wherein the electron shower is formed using raster scanning of the focused electron beam.

Aspect 32. The method as described above, below, and herein, wherein the liquid stream or liquid jet or liquid droplets is co-flowing with a gas jet.

Aspect 33. The method as described above, below, and herein, wherein the gas jet is used to control the velocity vector and kinetic energy of the liquid stream or liquid jet or liquid droplets.

Aspect 34. The method as described above, below, and herein, wherein the electron shower is focused or unfocused.

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### Example 1

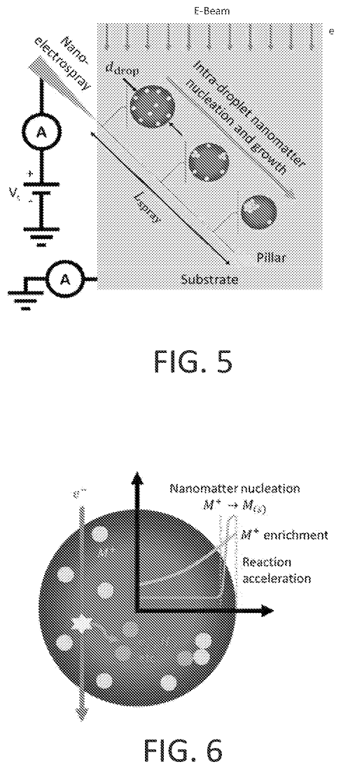

Predicting nano-matter growth behavior inside liquid nanodroplets in non-equilibrium conditions under defocused electron beam irradiation requires an understanding of the reaction and nucleation kinetics at play. The process from initial electron shower exposure to creation of solid nano-matter proceeds in three steps (FIG. 5). First, primary electrons from the electron shower interact elastically and inelastically with solvent molecules inside the nanodroplet, losing energy in inelastic collisions and producing highly reactive radiolysis products in the liquid phase. These radiolysis products may undergo further reactions with one another or other solvent molecules to produce secondary radiolysis species as well. In the case of a water-ammonia solvent, these primary and secondary radiolysis species include hydrogen, oxygen, hydroxide radicals, solvated electrons, hydrogen peroxide, and others.

FIG. 5 is an overview of the D2D-EBID system. A nanoelectrospray supplies electrically charged nanodroplets with precursor ions into the vacuum environment. A defocused electron shower interacts with the nanodroplets and causes nano-matter formation. The nanodroplets land on the substrate and the nano-matter assembles into a pillar-shaped nanostructure. The currents are measured both at the spray emitter and substrate for process control and fundamental understanding of the process dynamics.

Second, an aqueous phase precursor metal cation, e.g., Ag⁺, or ion complex, e.g., Ag(NH₃)₂⁺, reacts with a reducing radiolysis species, resulting in a neutral charge state metal atom. Finally, these neutral metal atoms nucleate either homogeneously (in the bulk) or heterogeneously (at the free surface) to form nanoclusters, which grow to stable solid-phase nanoparticles of tens to thousands of atoms inside the liquid solvent. In a nanoscale system such as the dispersed nanodroplets in an electrospray, the specific surface area is extremely large. The liquid-vacuum interface is distinct from the liquid bulk because the activation energy barrier for reactions of partially solvated species at the interface is reduced, leading to dramatically higher rates of the reactions relevant for nano-matter production (FIG. 6). Furthermore, although not intending to be bound by theory, heterogeneous nucleation at the liquid-vacuum interface may be the dominant step for solid growth initiation.

FIG. 6 illustrates nano-matter formation kinetics that are accelerated at the nanodroplet free surface. Primary beam electrons interact with solvent molecules, generating radiolysis products which can reduce metal precursor ions. Precursor ions are enriched near the surface and reduction and nucleation are favored in the interfacial region owing to reduced activation energy barriers and high flux gradients.

Because of the well-defined nature of the nanodroplet as a chemical reactor, the effects of multiple difficult-to-control variables present in other EBID processes are simplified or eliminated. Radiolysis product concentration gradients are mitigated because the high-energy primary electrons penetrate through the nanodroplets with negligible loss of energy. Without a solid substrate in contact with the liquid phase, the effects of type II secondary and backscattered electrons reemerging into the liquid domain are also mitigated. Together, these two factors lead to a spatially uniform generation of reducing and oxidizing species to interact with the metal precursor ions. Additionally, in a conventional thin-film LP-FEBID, there are two interacting interfaces in the system (liquid-vacuum and liquid-solid substrate), which presents challenges in separating the effects of each interface on the system behavior. The lack of a solid substrate in the nanodroplet system reduces this number to one (liquid-vacuum), allowing us to focus only on the influence of the liquid-vacuum interface (FIG. 6).

### Example 2

When nanodroplets carrying metal precursor ions and nucleated nanoparticles impact the substrate, they merge into a confined liquid spot in which further metal ion reduction and nucleation take place to assemble the individual nano-matter from each droplet into a single solid-phase nanostructure. As the nanostructure begins to form, the liquid droplets interact with the tip of the growing nanostructure through a thin interfacial liquid layer populated with nucleated nano-matter. The mode of growth and morphology (amorphous/porous vs. crystalline/monolithic) of the growing nanostructure are determined by the content of the impinging stream of nanodroplets upon interaction with low-energy electron beam electrons. Also, distinct regimes of higher growth rate and greater resolution of resulting nanostructures are defined by the size of the impinging nanodroplets in combination with the duration of e-beam exposure.

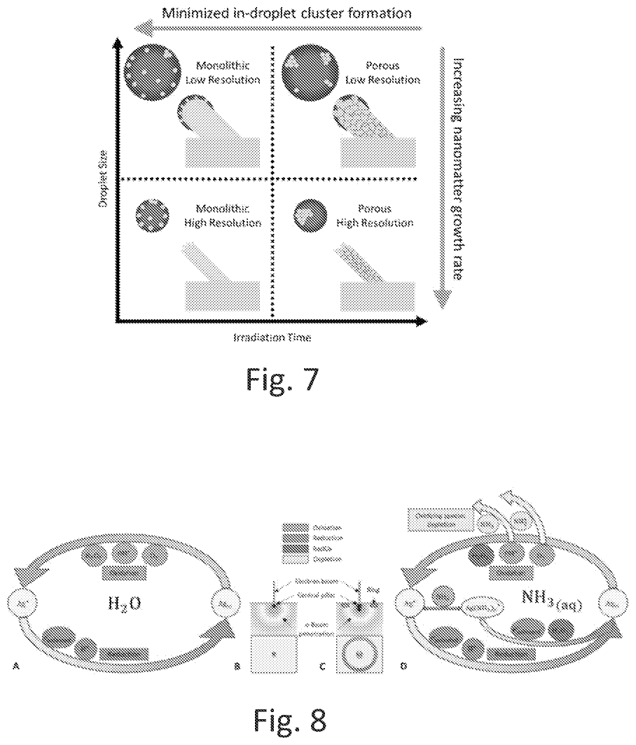

A longer exposure time to the electron shower allows more time for the radiolysis and reduction chemistry to proceed and hence increase the size of nucleated nano-matter within the nanodroplets. On the other hand, the size of the droplets (surface area-to-volume ratio) dictate the morphology and physical structure of the nano-matter that is used to form the nanostructure. As shown in FIG. 7, four regimes can be identified in respect to nanostructure resolution and morphology. It is expected that larger nanodroplets will lead to poorer deposit resolution (lower aspect ratio) because of the greater flow rate of liquid arriving at the deposition point and thus the larger and less controlled extent of the ultrathin liquid layer that drives the nanoparticle aggregation and/or fusion processes at the nanostructure tip. Additionally, for longer electron beam irradiation times, larger nanoparticles are formed within each nanodroplet, which will result in a porous nanostructure morphology due to an aggregation-dominated growth mode, when the contact area (per unit volume) is small. For shorter irradiation times, the nano-matter in the nanodroplets will be in the form of small clusters/nanoparticles with high specific surface area, amenable to the layered assembly of monolithic structures. The electrochemical reduction of precursor ions within the liquid interlayer at the interfaces of aggregated nanoparticles will act as an atomic “glue” that fuses the solid phase of the preexisting nanoparticles to produce the nanostructure. Importantly, the ultrasmall nanoparticles can move near the liquid-solid interface under the influence of Brownian motion and osmotic pressure and recrystallize onto the growing structure based on matching surface grain orientations, creating defect-free attachments to the existing nanostructure.

FIG. 7 illustrates possible regimes of nanostructure formation using D2D-EBID. At short irradiation times, nano-matter growth inside the nanodroplets is limited and an oriented assembly process on the growing nanostructure surface produces a monolithic structure. At long irradiation times, larger nanoparticles from the nanodroplets aggregate to form a porous nanostructure. For small nanodroplets, deposit resolution is maximized, and the nanostructures achieve a high aspect ratio. For large nanodroplets, an excess of liquid and its spreading at the deposition site may result in poor resolution and a decreased aspect ratio.

The mechanism of interlayer electrochemical “fusion” resulting in monolithic nanostructures is novel and fundamentally significant. The nanostructure growth and local metal deposition within an interlayer occur within the concept of a “virtual” e-beam electrode. The ultrathin liquid layer acts as a far-from-equilibrium electrolyte at the surface of the growing nanostructure, which plays the role of a “virtual” electrode for heterogeneous metal ion reduction.

### Example 3

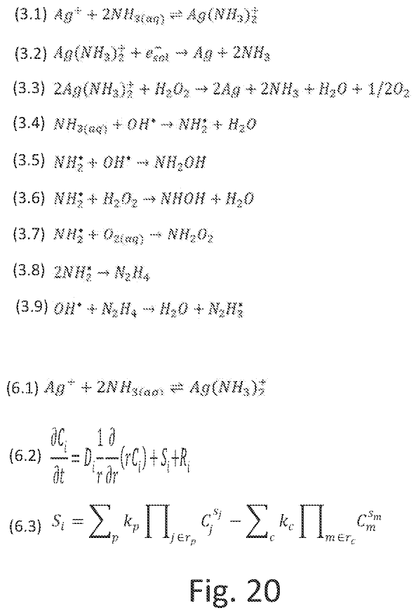

In the commonly used pure water solvent, AgNO₃ dissociates into Ag⁺ and NO₃⁻. Under electron irradiation, a process of radiolysis takes place, resulting in the creation of solvated electrons (e⁻ₛₒₗ), H*, H₂, OH*, H₂O₂, HO₃⁺, and HO₂* as primary radiolysis species. These species react with one another and the solution to form secondary radiolysis species such as O₂. The species of greatest significance for synthesis of Ag nanomaterials are the ones that either reduce Ag⁺ to Ag or oxidize Ag to Ag⁺. As shown in FIG. 8, e sol and H*, are the reducing species for Ag⁺, while H₂O₂, O₂, and OH* are species oxidizing Ag. At any point in space and time, the creation of an Ag solid phase is only possible if the rate of reduction is higher than the rate of oxidation. In the case of the water—AgNO₃ system, a net-reducing environment exists only at the point where electron beam interacts with solution, resulting in the creation of central pillar, as shown in FIG. 8. The rate of deposition is diminished by the presence of oxidizing species, such that only in a very small region near the electron beam impingement point can solid formation occur. The use of an aqueous ammonia solvent for AgNO: leads to a significant change in chemical behavior. The presence of ammonia in an aqueous solution triggers the formation of diamine silver ion complexes, Ag(NH₃)₂⁺, from Ag ions, Eq. 3.1 (See FIG. 20 for equations 3.1-3.9). This reversible reaction strongly favors the formation of Ag(NH₃)₂⁺, to the extent that free Ag⁺ concentrations are negligibly small for sufficiently high concentrations of ammonia. Ag(NH₃)₂⁺ can be reduced by e sol, via Eq. 3.2, to form metallic Ag. Ag(NH₃)₂⁺ can also be reduced by H₂O₂ to produce Ag. In the case of an AgNO₃ solution in pure water this reduction mechanism is absent, and H₂O₂ is only an oxidizer of Ag.

This means that the use of a water-ammonia solvent leads to a role reversal for H₂O₂ from solely an oxidizer to a reducer as well as an oxidizer. Consumption of H₂O₂ in the reduction of Ag(NH₃)₂⁺ leads to a decrease in the rate of Ag oxidation. Radiolysis of aqueous ammonia also creates additional chemical pathways that mediate Ag/Ag⁺ redox chemistry through the production of species such as NH₂* and the interaction of radiolysis species with N. Specifically, this leads to consumption of oxidizing species through the reactions (See FIG. 20).

As a result, the concentration of species oxidizing Ag is significantly suppressed in a water-ammonia solvent as compared to pure water, making the deposition environment more reducing.

### Example 4

Interfacial phenomena play a critical role in solvated electron driven chemistry, including (1) alteration of secondary electron yield in the vicinity of liquid/solid and liquid/vacuum interfaces, (2) changes in quasi-equilibrium distributions of solvated electrons and other species at interfaces (e.g., elevated or depressed concentration of charged species in the Debye layer), and (3) acceleration of electrochemical kinetics at the liquid/vacuum interface due to changes in reaction activation energy for partially solvated species. In electron beam-mediated deposition, the current state of the art is to use a focused electron beam interacting with an extended bulk liquid-phase precursor, where the limiting factors to 26 the achievable deposition resolution are the electron beam penetration in the precursor and radiolysis product diffusion length scales.

The present disclosure provides for a new approach, which we refer to as Droplet-to-Deposit (D2D) EBID, in which the resolution is defined by a precursor “beam” (i.e., stream of liquid or liquid jet or liquid droplets). In this approach, the material deposition is confined in the nano-electrosprayed dispersed liquid phase (e.g., nanodroplet in flight), where dissolved precursor ions are exposed to abundantly available electrons delivered by rastered, spatially defocused, low-energy electron beams, for example. This is a shift in how the LP-FEBIP deposition process occurs and how the underlying fundamental mechanism(s) of the electron-mediated chemistry are controlled to enable the next level of improvement in nanostructure spatial resolution, topology, and composition.

The basic building block for synthesis is the individual electrified nanodroplet containing precursor ions, which provides much finer control over the extent of deposition. As surface area per unit volume of a droplet scales inversely with radius, the behavior in the nanometer-scale droplet is dominated by surface phenomena while bulk transport effects are mitigated, which makes the nanodroplet a compelling medium for controlled electron-mediated deposition. The highly charged (through the electrospray process) nanodroplet constituents of the precursor beam are exposed to the extreme conditions of high vacuum and electron beam irradiation as they are delivered to their target substrate. As a result, the nanodroplet's solvent and the precursor undergo highly non-equilibrium transformations in composition, temperature, and phase change, with large fluxes at the interface.

High-aspect ratio pillar growth has been observed in NESA-FEBID experiments in which the electrospray conditions do not result in a distinct liquid film visible on the substrate. The pillar growth occurs when the electrospray droplets are subjected to defocused electrons while operating in scanning electron microscopy (SEM) imaging mode. The growth of the deposit is initiated at the spray impact site on the substrate and is observed to be in the direction of the nanoelectrospray jet. The high-aspect ratio pillar growth is an especially promising and scientifically unusual nanomaterial synthesis process. The pillar grows rapidly and at an angle consistent with direction of incoming electrospray so that the source of deposition is not a liquid film on the substrate but a beam of electrified, dispersed liquid phase precursor. This conclusion is supported by the observation that even if the pillar breaks during growth, a new pillar nucleates and continues growing in its place in same direction. It is important to emphasize that this new process produces no collateral deposition on the substrate, as under ideal conditions no liquid film is formed on the surface. These high-aspect-ratio pillar deposits show evidence of crystallinity and high metal purity (EDS indicates near-100% Ag content). Improved crystallinity is desirable in nanoscale manufacturing applications due to its positive effect on critical transport properties such as thermal and electrical conductivity of the nanostructures.

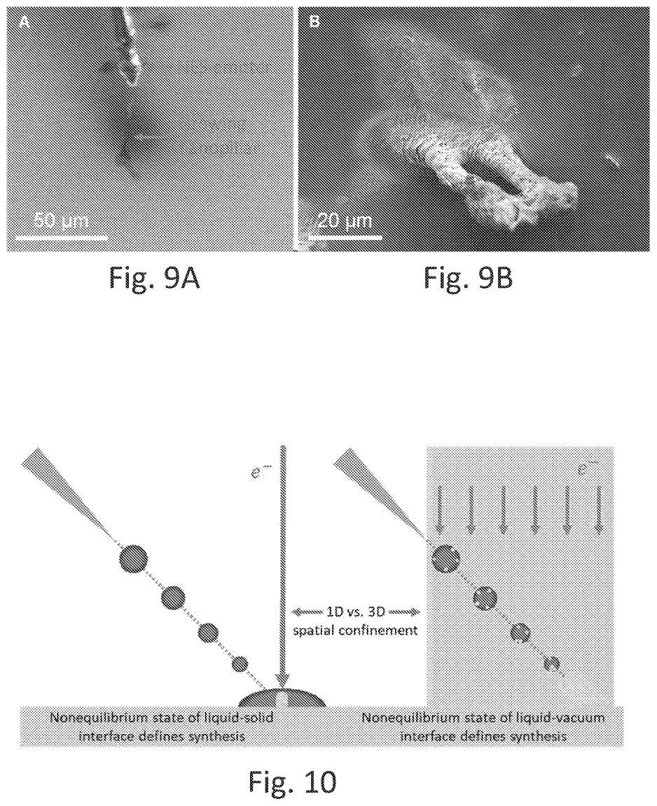

We have demonstrated the ability to produce high-aspect ratio 3D metallic deposits at very high growth rates on a conducting substrate using this method (FIG. 9). These deposits display the ability to achieve unique and complex topologies, including nanoscale bridging, and we have produced pillars reaching heights of about 35 μm. The use of a nanoelectrospray jet enables a direct-write capability for deposition by controlling the delivery of electrified droplets in the desired direction to the tip of the growing nanostructure while exposing it to an abundance of electron beam electrons. We have observed a linear growth rate of about 0.5 μm/s for the about 5 μm diameter pillars shown in FIG. 9B (about 10 μm³/s volumetric growth rate), which is approximately an order of magnitude higher than the ~1 μm³/s volumetric growth rate we have previously observed for thin film NESA-FEBID and 10⁴ times higher than the rate for heated-gas-jet-assisted gas phase FEBID.

FIG. 9(A) illustrates an electrosprayed precursor “beam” in D2D-EBID produces a high-aspect ratio nanopillar growing in outward direction from the liquid “beam” impingement spot on the substrate toward the nanoelectrospray emitter. Electrons are supplied throughout the domain by a low-energy defocused electron beam. FIG. 9(B) illustrates D2D-EBID that is used to create a 3D bridged structure formed by direct write of the precursor beam. Crystalline structure with high metal content is observed in the produced deposits.

### Example 5

FIG. 10 illustrates two techniques (film-on-the-substrate and in-flight-droplet spray) for liquid-phase precursor delivery. Electron beam assisted deposition with liquid phase (LP) precursors enables synthesis of high-resolution nanostructures at high growth rate and no off-target deposition. The left side of FIG. 10 illustrates ultra-thin film LP-FEBID that uses a water-ammonia solvent in extreme 1D confinement and chemical “lensing” of redox chemistry for highest deposit resolution on exposure to a focused e-beam. The right side of FIG. 9 illustrates droplet-to-deposit D2D-EBID that uses nanodroplets with 3D-confined, electrochemically energized liquid phase precursor irradiated by the low energy scanning e-beam for high aspect ratio, controlled shape nanostructures. The left side of FIG. 10 shows that a single e-beam is directed to a liquid precursor pool on the surface, while the right side of FIG. 10 shows a shower of electrons that are interacting with the droplets as the droplets move towards the surface, where the structure is formed on the surface without a liquid precursor pool. The use of the e-beam and liquid precursor pool results in the parasitic formation of material around the structure that is not desirable, whereas the shower of electrons interacting with the droplets does not form the parasitic material around the structure.

The right side of FIG. 10 illustrate that the deposition occurs within the confines of a stream of droplets, which act as dynamic electrochemically active “liquid nanoreactors” for e-beam induced solid nano-matter formation with an ionic precursor. Nanostructure growth occurs through droplet-nucleated nano-matter aggregation and fusion with the assistance of a lower energy scanning electron beam. The extreme surface area of ultra-small and spray droplets, in which the radiolysis-induced reactions occur, is advantageous and produces structures without the parasitic deposition of material adjacent the structure.

### Example 6

Introduction Techniques using focused electron beams generally have the potential to lead to the highest resolution nanostructure synthesis. Extensive research has been conducted on the application of the focused electron beam for the fabrication of nanostructures, demonstrating its effectiveness, precision and versatility across nano-and microscales.^{[1]} The utility of Focused Electron Beam Induced Deposition (FEBID) has been shown in material science applications, including nanoelectronics, optics, nanoprobes, plasmonics, and magnetics.^{[2]} Beam-based fabrication provides the ability to create nanostructures atom-by-atom on suspended atomically thin substrates with minimal parasitic co-deposition effects.^{[1]} However, this potential for “spot-on” synthesis is yet to be fully realized especially in an environment that meets requirements relevant to practical applications. The most commonly used FEBID approach, gas phase electron beam induced deposition, suffers from low growth rate and impurities due to parasitic carbon entrapment. [2b] Increasing growth rates often leads to unwanted deposition, compromising resolution, ^{[3]} as, in direct-write nanofabrication, there is a general tradeoff between growth rate and resolution. In this work, we describe an approach to resolve this fundamental tradeoff between growth-rate and resolution, with a technique we call ‘electrochemical lensing’. Electrochemical lensing exploits principles of electrochemistry and transport to facilitate high growth rates without sacrificing resolution.

Use of liquids as a precursor for FEBID (LP-FEBID) has been shown to offer higher growth rates, higher purity, and a greater selection of precursors as compared to gas phase precursors. ^{[4]} For high resolution FEBID, the process takes place inside a vacuum chamber where rapid evaporation makes the use of liquid phase precursors challenging. Enclosed cells, with electron transparent membranes, can be employed to isolate the liquid from the vacuum environment, and are useful for fundamental studies. ^{[5]} However, for practical applications that demand precise control of precursor concentration, broad substrate selection, and the creation of complex three-dimensional nanostructures, electron beam deposition in a free-surface liquid film offers many advantages and flexibility despite the challenges inherent in creating a film in vacuum. In one free-surface approach, LP-FEBID has been applied to the bulk liquid layer formed via condensation in an environmental (low vacuum) scanning electron microscope (ESEM). ^{[6]} Combinations of ESEM with microwells^{[6a]} and liquid injected via nanocapillaries^{[7]} have also been used to create thick liquid films for FEBID. In these approaches, the thickness of the liquid film has proven problematic, as the beam electrons cannot penetrate the liquid and deposits are strongly affected by the moving liquid, often failing to even adhere to the substrate. The development of Nanoelectrospray Assisted Focused Electron Beam Induced Deposition (NESA-FEBID), on the other hand, addresses this difficulty as it enables creation of a stable and ultra-thin liquid film in high vacuum. ^{[8]} Recent studies using NESA FEBID have demonstrated that the choice of solvent for LP-FEBID can have significant effects on the chemistry of the process with implications for both ease and rapidity of nanostructure synthesis. For instance, the use of a pure water solvent has been shown to be challenging for creating the stable liquid films necessary for spatial control of beam-guided synthesis and can also lead to a highly oxidizing electrochemical environment, slowing growth and thus lessening the inherent advantage of LP-FEBID.

The addition of ammonia to an aqueous solution has been shown to promote nanomaterial synthesis due to its ability to make the chemical environment more reducing. ^{[9]} The presence of ammonia in water leads to an environment around the primary e-beam irradiation site that is highly reducing for metal cations (favorable for electrochemically induced metal deposition) due to (1) the switching of the behavior of the radiolytically generated hydrogen peroxide from purely oxidizing to dual reducing/oxidizing, and (2) locally depressed concentrations of short-lived oxidizing species from radiolysis consumed by NH₃ and NH₂* that act as scavengers of oxidizing species.^{[9]} However, high ammonia concentrations can also lead to fast growth of unwanted co-deposits away from the desired nanostructure formation location. Controlling the spatial distribution of the solid matter deposited in and around the primary electron beam irradiation site is mediated by the species transport and is crucial for achieving high resolution in electron beam synthesis for direct-write applications.

A promising strategy in spatial control of electron beam guided synthesis is to take advantage of a water-ammonia solvent that creates a reducing radiolysis environment in the immediate vicinity of primary electron beam impingement (the “near-field” region). At the same time, an oxidizing environment (such as that present when pure water is the solvent) could be established outside of the primary beam impingement site, i.e., the location of high electron dose rate, or the “far-field” region. Exploiting the interplay between the redox species transport and reactions in this dual-domain environment enables an ‘electrochemical lensing’ effect, where the growth of nanostructures is precisely ‘focused’ at the near-field, while unwanted growth in the far-field is suppressed.

Uncovering and quantifying the interplay between the reaction and transport of chemical species that yields the electrochemical lensing phenomenon is the focus of this paper, which is organized as follows. First, NESA-FEBID synthesis is described, focusing on the physicochemical state of the liquid film. Then we describe relevant chemical pathways taking place in the ammonia-water solution with dissolved silver nitrate precursor during electron beam irradiation. A reaction-transport model is presented and insights from simulations are used to reveal the mechanisms resulting in the desired electrochemical lensing effect. Finally, the results of simulation are validated using corroborating experiments and generalized to broader conclusions relevant to other electrochemical synthesis methods.

### Results and Discussion

### FEBID Synthesis in NESA Films

We use a NESA-FEBID process with ammonia-water as solvent and dissolved silver nitrate (AgNO₃) salt as a source of cations for Ag deposition. The presence of ammonia in the solution leads to a rapid equilibrium between Ag⁺ ions and silver diamine ion complexes, Ag(NH₃)₂⁺, Eq (6.1) (See FIG. 20), which favors greater Ag(NH₃)₂⁺ concentrations with increasing ammonia content.

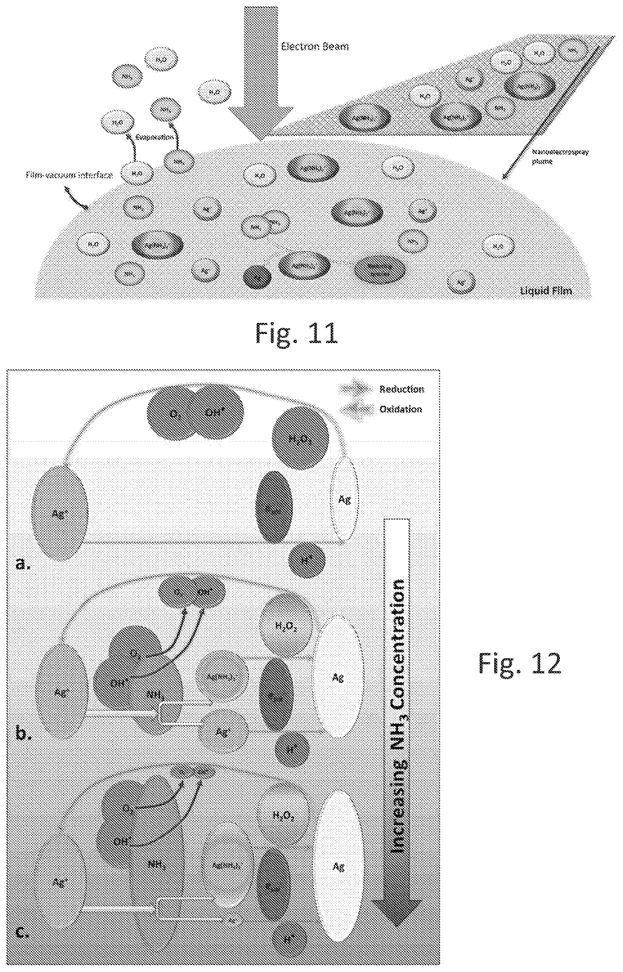

In NESA-FEBID, FIG. 11, irradiation of the liquid film by the electron beam results in radiolytic production of chemically reactive species. High energy electrons undergo elastic and inelastic collisions with the solvent molecules. This results in a transfer of energy from the electron beam to the liquid and leads to radiolysis, resulting in the creation of primary radiolytic species such as solvated electrons, esol, as well as H^{·}, H₂O₂, HO₃⁺, OH^{·}, HO₂^{·}, NH₂* and H₂. These primary radiolytic species then undergo reactions with each other and the solution, leading to the creation of secondary radiolytic species such as O₂ and N₂H₄. ^{[9-10]} Both primary and secondary radiolytic species diffuse away from their region of formation to react with the precursor, the solvent, and one another both in the near-field and far-field regions of the film.

### Reaction Pathways Essential to Nanomaterial Synthesis

In NESA-FEBID of AgNO₃/ammonia-water, silver metal formation occurs through the reactions shown in FIG. 12, which substantiates the impact of changing ammonia concentration.

In an environment where pure water serves as the solvent (FIG. 12a), an overall oxidative condition prevails, which significantly inhibits the rapid growth of nanomaterials. The species of greatest significance for synthesis of Ag nanomaterials are the ones that either reduce Ag⁺ and Ag(NH₃)₂⁺ to Ag or oxidize Ag to Ag⁺ . In the absence of NH₃, the Ag⁺ from dissociated AgNO₃ is reduced to Ag by solvated electrons esol and hydrogen radicals H^{·}. The Ag formed can then be converted back to Ag⁺ by oxidizing species, H₂O₂, OH and O₂. The net rate of Ag creation is determined by the difference in rates of silver cation reduction and silver atom (solid phase) oxidation (FIG. 12a). The introduction of ammonia changes the deposition landscape in multiple ways (FIG. 12b).

Firstly, in the presence of ammonia, the silver ions (Ag⁺) are partially converted to silver diamine, Ag(NH₃)₂⁺. This introduces an additional reduction pathway to solid Ag formation.

Secondly, the role of H₂O₂, a primary radiolytic species, shifts from being exclusively an oxidizer for Ag to also being a reducing species. Hydrogen peroxide reduces precursor Ag(NH₃)₂⁺ to form silver, and also reduces oxidizing species OH^{·} and O₂, leading to their diminished concentration. The net effect is a significantly enhanced rate of solid Ag deposit creation, through both an increase in the reduction to Ag and a decrease in oxidation of Ag. Ag(NH₃)₂⁺ also acts as an additional source of ammonia as each ion-complex releases two ammonia molecules into the film upon reduction (FIG. 11). Increasing ammonia concentration even further amplifies these effects (FIG. 12c). At high ammonia concentrations, nearly all dissolved silver precursor is in Ag(NH₃)₂⁺, enhancing the role of H₂O₂ as a reducer. Additionally, the oxidizing species are highly suppressed, leading to higher net growth rates of Ag. Reaction-diffusion simulations were used to obtain detailed insights into the processes leading to variation of net reducing versus oxidating behavior as function of spatial location and time.

### Analysis of Reactions and Transport

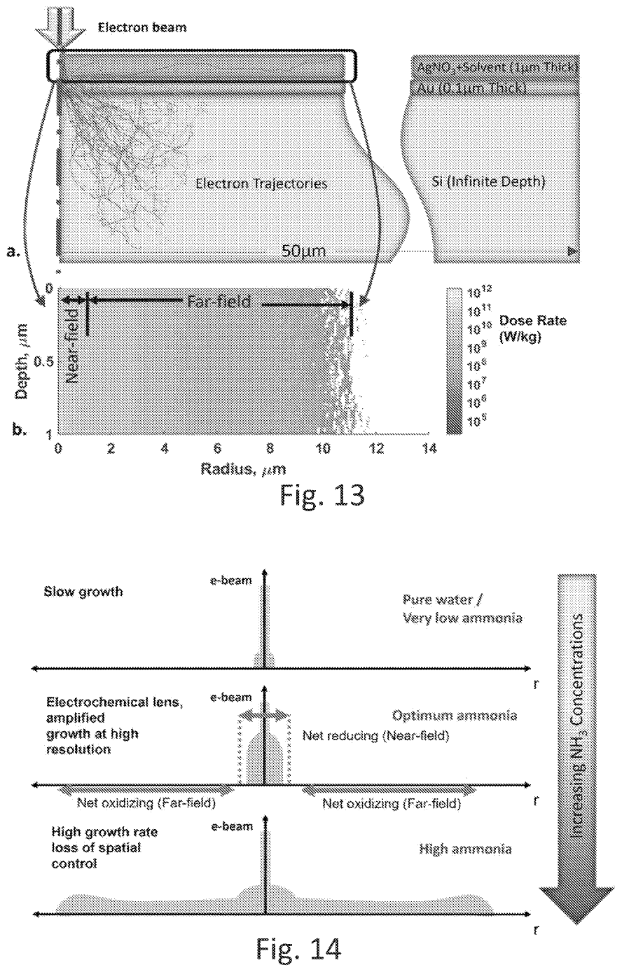

A transient mass conservation and species transport model is used to simulate the dynamic interplay between chemical reactions and the diffusion of species within the system. The liquid film, depicted at the top of the diagram in FIG. 13a, is very thin owing to the nanoelectrospray delivery, such that the rate variations across it could be ignored for a quasi-1D axisymmetric treatment (FIG. 13b). Rather than introduce assumptions regarding the solid phase nucleation process, we use the Ag concentration as a proxy for nanostructure creation.^{[9]} This allows us to treat solid metal reduction and oxidation as homogeneous processes with a correction factor accounting for heterogeneous (confined to the interface) nature of oxidation. Additionally, the effects of advection and electromigration are not considered, and Fickian diffusion is assumed. These assumptions have been shown to accurately capture the key processes and predict electron mediated metallic nanomaterial synthesis.^{[9]} The variation of the concentration of species i, Cᵢ, with time and radial position, t and r, respectively, is given by the (6.2) in FIG. 20.

Dᵢ is the diffusion coefficient of species i, Sᵢ is the net rate of production/consumption by homogeneous chemical reaction, and Rᵢ is the net rate of production by radiolytic processes. The homogenous reactions are treated as elementary reactions, i.e., where, kᵥ and kₑ and the rate constants for the chemical reactions producing species i, r_{D}, and consuming species i, r_{c}, respectively.

The exponents sⱼ and sₘ represent the associated stoichiometric coefficients. The source term representing net creation or consumption by radiolysis, Rᵢ, is given by Rₜ=G₁ψ where the G-value, Gᵢ, is solvent dependent and gives the moles of species i created per unit energy of electron beam absorbed, and ψ is the local rate of energy deposition from e-beam irradiation, found using azimuthally and axially integrated values from Monte Carlo simulations implemented in CASINO, divided by thickness and circumference to obtain local average values for the 1-D simulations. The chemical reactions, the rate constants and G-values utilized are specified in our previous work.^{[9]}

The reaction source term, [symbol] , as given in Eq. (3), is for homogenous reactions; however, the metallic silver produced by the NESA-FEBID process will eventually nucleate to form a nanostructure, a process that cannot be modeled explicitly in the 1-D formulations. In growing nanostructures, only the Ag present on the solid deposit surface remains exposed and susceptible for oxidation, via heterogeneous reactions. As a solid deposit increases in size its surface-to-volume ratio decreases, as does the proportion of Ag available for oxidation relative to the total amount of Ag locally present. To account for decreased availability of Ag for oxidation after nucleation, while maintaining the simplicity of a homogenous reaction model, we assume that the reaction rate of silver atoms on the surface of deposits follows the same rate expression as in the bulk, but only consider surface atoms as contributing to the concentration of Ag participating in the oxidation reaction. This approach is accomplished by modifying the form of the Ag oxidation expression with a dimensionless prefactor, f, that is a function of silver concentration: f=min (C*/C_{ag}, 1), where the value of the reference concentration C* is based on the molar density of solid silver and the film thickness (1 μm), C*−38.33 mol/m³.

In NESA-FEBID, sprayed non-volatile species concentrations will continuously increase, while volatile species concentrations reach a steady state (FIG. 11). We consider two initial silver salt concentrations, 26.5 mM and 265 mM, which are the concentrations occurring at 1 s and 10 s, respectively, within a film of 50 μm radius and 1 μm thickness formed via introduction of a 250 μM AgNO: solution at a rate of 3 μL/hr. Initial free (not bound in silver diamine) dissolved ammonia concentrations in the film vary from ~100 μM up to 3 M, which corresponds to the steady-state concentration achieved assuming evaporation at the kinetic limit to vacuum from a film of 50 μm radius and 1 μm thickness formed via introduction of a 5% to 30% w/w ammonia concentration in water at a rate of 3 μL/hr (typical experimental conditions). The initial concentration of silver ions and silver diamine ions is based on the total initial AgNO₃ concentration, the initial ammonia concentration, and the equilibrium condition, Eq. (6.1). Zero flux in far field and axial symmetry boundary conditions are used on the two domain boundaries.

### Electrochemical Lensing: Insights From Simulations

Electrochemical lensing is the phenomenon in which the transport and reaction interaction result in preferential growth in the near-field while minimizing nanostructure deposition in the far-field, a phenomenon which can be exploited to achieve high resolution deposits as shown schematically in FIG. 14.

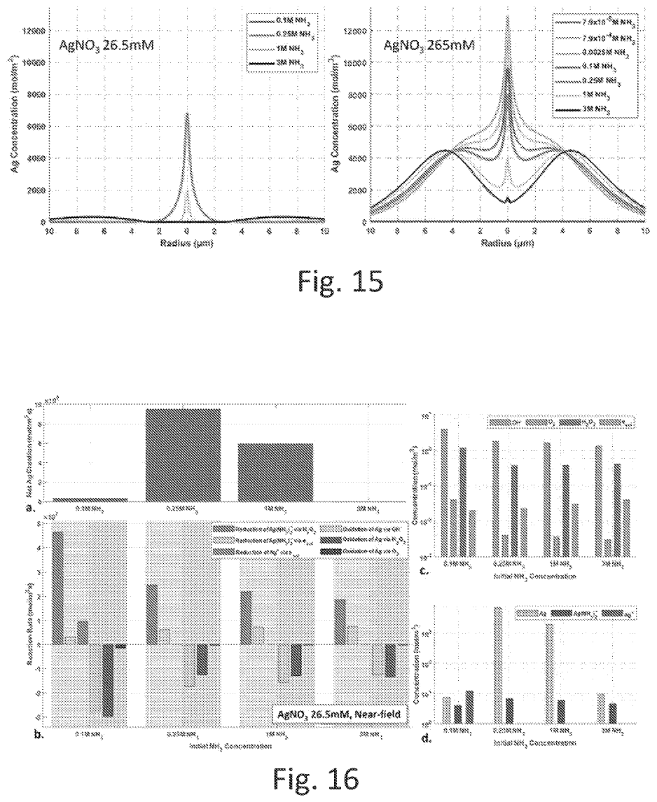

To demonstrate the effect of ammonia content on deposition, we perform simulations at multiple ammonia concentrations. The key result of simulations is the concentration of Ag, which serves as a proxy for silver nanostructure growth. FIG. 15 shows the resulting Ag concentrations for various NH₃ initial concentrations after a 1 s exposure of the film to a 30 kV electron beam.

For the lower silver precursor concentration, 26.5 mM, electrochemical lensing is observed at an intermediate ammonia concentration (FIG. 15a). Negligible silver formation is observed after 1 second of beam exposure when the initial free NH₃ concentration is 0.1 M: for this precursor concentration and small initial concentration of free ammonia, the entire domain remains net oxidizing for silver. When the NH₃ concentration is increased to 0.25 M, the near-field environment becomes reducing, and Ag growth commences at the point of electron beam impingement, while the far-field continues to be oxidizing, thus, preventing Ag production away from the e-beam irradiation. This distribution of Ag formation, resulting from creation of a reducing environment in the near-field only, is the hallmark feature of electrochemical lensing. As the NH₃ concentration is further increased to 1 M, both the near-field and far-field environments become reducing, resulting in broadening of the area of net silver reduction. The strongly reducing environment not only leads to a higher rate of conversion of Ag⁺ and Ag(NH₃)₂⁺ precursor ions into Ag in the far-field, but also, in turn, decreases the availability of these precursor ions for diffusion towards the near-field. Consequently, the central Ag pillar experiences a precursor shortage, slowing its growth as compared to the rate observed at 0.25 M NH₃. This effect is even more pronounced for higher concentrations of ammonia: for initial NH₃ of 3 M, significant far-field Ag formation occurs while central deposit formation is very limited.

Electrochemical lensing is not observed for all precursor silver salt concentrations. When initial AgNO₃ is 265 mM, even very small initial concentrations of free ammonia correspond to rapid and widespread Ag formation (FIG. 15b). In part this is due to the presence of significant “bound” ammonia locked in the Ag(NH₃)₂⁺ complex. When silver diamine is reduced, NH₃ enters solution, resulting in an increase of ammonia concentrations (FIG. 11). Thus, while at extremely low initial free ammonia levels (79 μM), silver growth is negligible, high rates of near-field deposition are achieved even with only 0.79 mM of initial free ammonia. However, the lensing effect that occurs at the lower salt concentration is diminished, with significant net reduction occurring outside the near-field region, as NH₃ released during Ag(NH₃)⁺ reduction, diffuses to the far-field. At higher ammonia concentrations (2.5 mM to 3 M), silver growth is even more pronounced in the far-field, leading to formation of volcano-like structures (FIG. 15b).

Simulations reveal details of the fundamental principles for the observed deposition behavior as a function of ammonia and silver salt concentration. FIG. 16 depicts key reaction rates and concentrations in the near-field (center) 1 sec after electron beam irradiation of a 26.5 mM silver nitrate film for four representative initial ammonia concentrations. In addition to the instantaneous rate of silver creation (FIG. 16a), which mirrors the results showing net silver produced in the near-field from FIG. 15a, FIG. 16b depicts the dominant reduction and oxidation reaction rates. Even at the lowest ammonia concentration, 0.1 M, solvated electron reduction of Ag⁺ has been supplanted as the dominant Ag production route by H₂O₂ reduction of Ag(NH₃)₂

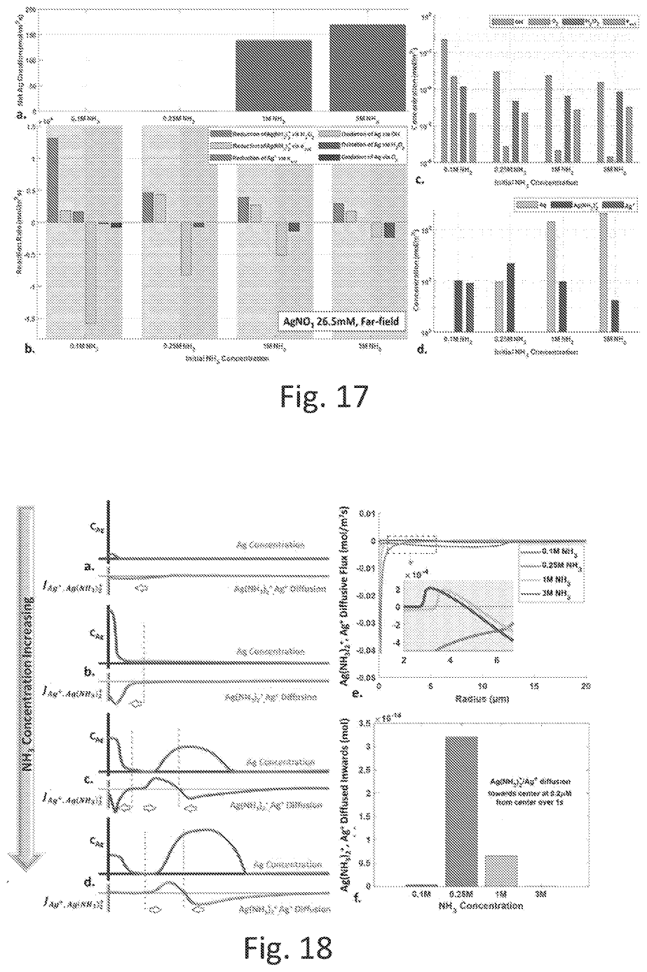

The higher rate of silver production at 0.25 NH₃ ammonia is not due to higher rates of reduction but a more significant decrease in the rate of oxidation than in the rate of reduction. In particular, the consumption of oxidizing species OH^{·} and O₂ by NH₃ and radiolytically produced NH₂*, as evident in FIG. 16c, is responsible for the higher net silver production rate. The diminished Ag production with further increases of NH₃ concentrations to 1 M and 3 M corresponds with a decrease in the concentration of Ag(NH₃)₂⁺ in the near-field, FIG. 16d, which is due to consumption of the precursor during far-field silver production which prevents it from being available to diffuse to the center. FIG. 17 depicts reaction rates and concentrations of key redox-mediating species in the far-field (4.5 μm from the center) for four representative initial ammonia concentrations 1 s after electron beam irradiation of a 26.5 mM silver nitrate film. As was seen for moderate ammonia concentrations in the near-field, increasing rates of silver production in the far-field at higher ammonia concentrations (FIG. 17a) are due primarily not to the increased rates of reduction, but as a result of even greater decrease in the rates of oxidation (FIG. 17b). The oxidizing species OH^{·} and O₂ are formed by radiolytic processes in the near-field and must diffuse to the far-field. As NH₃ concentration is raised, more OH^{·} and O₂ are scavenged prior to reaching the far-field, FIG. 17c. This leads to a faster drop in the rates of oxidation with increasing ammonia concentration than in the rates of reduction. As a result, net Ag creation occurs in the far-field for these NH₃ concentrations. The reducing environment in the far-field also leads to a drop in concentration of the precursor Ag(NH₃)₂⁺ as it is consumed in the H₂O₂ mediated reduction reaction, FIG. 17d. This leads to a decrease in the rate of Ag(NH₃)₂⁺ diffusion into the near-field and a slower growth of Ag in the near-field.

FIG. 18 depicts in greater detail the role of transport on silver deposition rates at different locations. A film consisting of extremely low (or none) NH₃, FIG. 18a, will lead to an overall oxidizing environment. This yields very little or no creation of Ag anywhere. Additionally, very little conversion of Ag⁺ and Ag(NH₃)₂⁺ to Ag causes a very small concentration gradient of Ag⁺ and Ag(NH₃)₂⁺ and consequently a very small diffusion flux. At optimum NH₃ concentration, FIG. 18b, reducing conditions are established at the near-field, while conditions at the far-field remain oxidizing. This leads to conversion of precursor, primarily Ag(NH₃)₂⁺, to Ag in the near-field, with precursor supplied to the near-field by diffusion from the far-field.

At higher NH₃ concentrations, FIGS. 18c and 8d, precursor is reduced to Ag both in the near-field and far-field. This leads to growth of Ag in the far-field, as well as slowing down of growth of Ag in near-field by decreasing the diffusion of precursor towards the near-field. FIG. 18e shows the amount of Ag⁺ and Ag(NH₃)₂⁺ that diffuse towards the near-field. The ammonia concentration (0.25M) associated with the highest magnitude diffusion flux is the one at which electrochemical lensing effect occurs.

### Electrochemical Lensing—Corroborating Experiments

To corroborate our simulation results, we conducted a series of experiments using NESA-FEBID with a 250 μM AgNO₃ solution, under a 30 kV electron beam for 1 second.

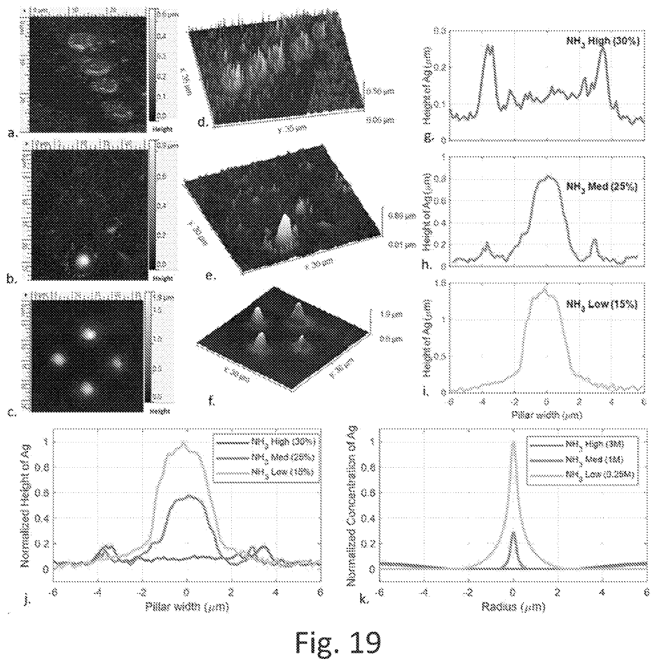

We explored the effects for varying NH₃ concentrations in the solvent. Attempts to form silver deposits using AgNO₃ dissolved in pure water (no ammonia) were not successful, supporting the simulation predictions of suppression of Ag growth in a highly oxidizing environment. Line and square arrays of nanostructures (to ensure repeatability) deposited from initial 30%, 25% and 15% ammonia-water NESA-FEBID solutions (corresponding to 3, 1 and 0.25 M ammonia concentrations in the film) were analyzed via Atomic Force Microscopy (AFM). FIGS. 19a to 19i show both two-and three-dimensional images and the radial profiles of these nanostructures. To compare the experimental results with the simulations, normalized pillar heights from the experiments, FIG. 19j, were compared to the normalized Ag concentration profiles obtained for different film NH₃ concentrations from the simulations, FIG. 19k.

Experimental silver creation follows the expected behavior with negligible silver growth in pure water, and a silver peak created in the near-field at 15% NH₃ NESA-FEBID solution with very little far-field growth. Increasing the concentration of NH₃ to 25% and 30% in the NESA-FEBID solution led to a higher Ag growth in the far-field and slower Ag growth in the far-field and a slower Ag growth in the near-field. This trend, predicted by simulations and confirmed by experiments, demonstrates the electrochemical lensing concept obtained when metal precursor cation is converted into its diamine complex enabling radiolytically produced H₂O₂ to act as a dual reducer and oxidizer. This leads to a high growth rate synthesis of high aspect ratio nanostructures in the near-field with corresponding increase in resolution. At high ammonia concentration, ammonia levels are sufficient to result in scavenging of oxidizing species, preventing them from diffusing from near-field to far-field, so that reducing species that diffuse to the far-field can react with precursor cations, producing a solid deposit, which prevents precursor from diffusing into the near-field. At lower ammonia levels, lesser conversion of precursor cation to its diamine form, keeps H₂O₂ acting mainly as an oxidizer. This results in higher oxidation rates than reduction, limiting nanostructure formation.

### Conclusion

We present an approach to resolving the fundamental tradeoff between the growth rate and resolution in electron beam mediated direct-write nanofabrication through the technique of electrochemical lensing. When deposition processes are governed by systems with a linear behavior, the increase in concentration of a reactant, even locally at the desired deposition location, will result in a broader deposition region due to diffusion. Electrochemical lensing is accomplished via introduction of intentional non-linearity into the system. Metal nanostructure synthesis using FEBID from silver salt in a water-ammonia solution is a demonstration of electrochemical lensing, in which the strong non-linearity of the system's response to changing ammonia concentration comes from the multiple roles played by ammonia in the system: (1) by binding silver cations into diamine silver complexes, ammonia adds a new reduction pathway involving hydrogen peroxide and provides a mechanism for ammonia storage in the solution; (2) by using both ammonia and its radiolytic decomposition product NH2 to selectively scavenge oxidizing species. Generalization of the approach therefore requires seeking similarly complementary nonlinearities for exploitation either through use of a solvent for forming multiple forms of a cation whose reduction leads to solid formation and/or encoding the redox switchable behavior to one or more transient intermediary species that facilitates the synthesis reaction. Electrochemical lensing as a conceptual model for synthesis improvement could play a significant role in a wide variety of nanomanufacturing applications, offering a scalable, precise, and efficient pathway for the creation of nanostructures with greater control of shape and resolution.

### Methods

### Experiment

A HPLC grade deionized water (Sigma Aldrich) and an HPLC grade water-ammonia solution (Fisher) were used for all experiments. Silver nitrate salt (Sigma Aldrich) was dissolved in water and mixed with water-ammonia to achieve desired concentrations. A TA Hamilton 1750 TLL syringe was used to deliver the solution at 3 μL/hr via a syringe pump. The solution nanoelectrospray was carried out using a fused silica capillary emitter (360 μm outer diameter, 100 μm inner diameter, pulled to a 3±1 μm diameter tip using a Sutter P-2000 Laser-Based Micropipette Puller). The substrate was a 1 cm×1 cm square Si wafer coupon with a 100 nm gold coating. The capillary to substrate distance is maintained at ~200 μm. The negative mode nanoelectrospray was initiated by electrically biasing the solution with −500 V at the metallic union using a SRS 5 kV power supply. Experiments were conducted using the FEI Quanta 200 SEM operated in high vacuum mode (~10-4 torr). To distinguish nanostructure deposits from salt precipitates, Nanometer Pattern Generation System (NPGS) exposed the film in a predefined pattern of four 1-second spots, facilitating the formation of discernible nanostructures. Post-deposition, the samples were immersed in water for 2 hours and subsequently dried. The Bruker Dimension Icon was used to perform AFM imaging.

### Simulation

Monte Carlo simulations were executed using the CASINO software. The model involving the reaction and transport of species was implemented in COMSOL Multiphysics software.

### REFERENCES FOR EXAMPLE 6

[1] S. Jesse, A. Y. Borisevich, J. D. Fowlkes, A. R. Lupini, P. D. Rack, R. R. Unocic, B. G. Sumpter, S. V. Kalinin, A. Belianinov, O. S. Ovchinnikova, ACS Nano 2016, 10, 5600-5618.
[2] a) A. G. Fedorov, S. Kim, M. Henry, D. Kulkarni, V. V. Tsukruk, Applied Physics A 2014, 117, 1659-1674; b) R. Winkler, J. D. Fowlkes, P. D. Rack, H. Plank, Journal of Applied Physics 2019, 125.
[3] S. Kim, A. G. Fedorov, in Nanofabrication, IOP Publishing, 2020, pp. 12-11-12-26.
[4] E. U. Donev, J. T. Hastings, Nano Letters 2009, 9, 2715-2718.
[5] a) G. Schardein, E. Donev, J. Hastings, Nanotechnology 2011, 22, 015301; b) P. S. EA Sutter, Journal of the American Chemical Society 2014, 136; c) L. E. Ocola, A. Joshi-Imre, C. Kessel, B. Chen, J. Park, D. Gosztola, R. Divan, Journal of Vacuum Science & Technology B 2012, 30, 06FF08; d) M. Bresin, A. Chamberlain, E. U. Donev, C. B. Samantaray, G. S. Schardien, J. T. Hastings, Angewandte Chemie International Edition 2013, 52, 8004-8007.
[6] a) S. Esfandiarpour, L. Boehme, J. T. Hastings, Nanotechnology 2017, 28, 125301; b) M. Bresin, A. Botman, S. J. Randolph, M. Straw, J. T. Hastings, Microscopy and Microanalysis 2014, 20, 376-384.
[7] S. J. Randolph, A. Botman, M. Toth, RSC advances 2013, 3, 20016-20023.
[8] a) J. S. Fisher, P. A. Kottke, S. Kim, A. G. Fedorov, Nano Letters 2015, 15, 8385-8391; b) J. S. Fisher, P. A. Kottke, A. G. Fedorov, Materials Today Physics 2018, 5, 87-92.
[9] A. Ahmed, E. C. Boyle, P. A. Kottke, A. G. Fedorov, Science Advances 2021, 7, eabj8751.
[10] T. J. Woehl, P. Abellan, Journal of Microscopy 2017, 265, 135-147.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A system comprising:
a broad electron beam system for generating a shower of electrons, wherein the shower of electrons has a width of about 1 mm to 1 cm and a length of about 1 mm to 1 cm, wherein the shower of electrons has an energy of about 10 eV to 10 keV with a current of about 1 pA to 1 mA; and
a spray system for directing a stream of liquid or liquid jet or liquid droplets into the shower of electrons, wherein the shower of electrons and stream of liquid or liquid jet or liquid droplets are under a pressure of about 10⁻⁶ bar to 760 Torr, wherein a portion of the shower of electrons collide with the stream of liquid or liquid jet or liquid droplets, wherein a solid nano-matter is formed via the chemical reactions in the stream of liquid or liquid jet or liquid droplets during interactions with the electron shower and forming a solid structure on collision with a substrate.

2. The system of claim 1, wherein the pressure is about 5 Torr to 760 Torr.

3. The system of claim 1, wherein the liquid from the spray system does not form a liquid film on the substrate.

4. The system of claim 1, wherein the broad electron beam system includes a source of electrons and electron focusing optics for controlling the flux and direction of shower of electrons.

5. The system of claim 1, wherein the spray system is a non-electrospray system.

6. The system of claim 5, wherein the non-electrospray system is an inkjet printhead, an acoustic droplet generator, or a pressure-driven liquid atomizer.

7. The system of claim 5, wherein the droplets have a diameter of about 10 nm to 100 μm as they exit the non-electrospray system.

8. The system of claim 5, wherein the liquid stream or jet has a diameter of about 10 nm to 100 μm as they exit the non-electrospray system.

9. The system of claim 5, wherein the spray system has a liquid delivery rate of about 0.01 nL/s to 100 μL/s.

10. The system of claim 1, wherein the spray system is an electrospray system that includes an electrospray capillary tip.

11. The system of claim 10, wherein the electrospray system has a liquid delivery rate of about 1 nL/s to 100 nL/s.

12. The system of claim 1, further comprising a temperature sensing and control element to control temperature of the substrate.

13. The system of claim 1, wherein the spray system includes the temperature sensing and control element to control the temperature of the substrate.

14. The system of claim 1, wherein the substrate is configured to move along or rotate about the x-axis, y-axis, and/or z-axis; wherein the spray system is configured to move along or rotate about the x-axis, y-axis, and/or z-axis; or both.

15. (canceled)

16. The system of claim 1, wherein the shower of electrons has an energy of about 100 eV to 250 eV with a current of about 10 pA to 10,000 μA.

17. The system of claim 1, wherein the pressure is about 10⁻⁶ to 5 Torr.

18. The system of claim 1, wherein the spray system has a liquid delivery rate of about 1-100 nL/s.

19. The system of claim 1, wherein the spray system is an electrospray system that includes an electrospray capillary tip, wherein the electrospray capillary tip has an orifice diameter of about 100 nm to 100 μm.

20. The system of claim 1, wherein the spray system is an electrospray system that includes an electrospray capillary tip, wherein the electrospray capillary tip has an orifice diameter of about 1 μm to 10 μm.

21. A method, comprising:
directing a stream of liquid or liquid jet or liquid droplets towards a shower of electrons, where a portion of the shower of electrons collide with the liquid stream or liquid jet or liquid droplets, and
forming a nano-matter as a result of the shower of electrons interacting with the liquid stream or liquid jet or liquid droplets which collide with a substrate and forming a solid structure,
wherein the shower of electrons, the liquid, and the structure are under a pressure of about 10⁻⁶ bar to 760 Torr, wherein the shower of electrons have an energy of about 10 eV to 10 keV with a current of about 1 pA to 10 μA.

22-43. (canceled)
